(19) United States
(12) Patent Application Publication
(10) Pub. No.: US 2026/0020042 A1
(43) Pub. Date: Jan. 15, 2026

(54) TECHNIQUES FOR PARTIAL SIDELINK TRANSMISSION USING WIDEBAND OPERATIONS

(71) Applicant: QUALCOMM Incorporated, San Diego, CA (US)

(72) Inventors: Hao XU, Beijing (CN); Siyi CHEN, Beijing (CN); Shaozhen GUO, Beijing (CN); Chih-Hao LIU, San Diego, CA (US); Xiaoxia ZHANG, San Diego, CA (US); Jing SUN, San Diego, CA (US); Changlong XU, Beijing (CN); Luanxia YANG, Beijing (CN)

(21) Appl. No.: 18/881,039

(22) PCT Filed: Aug. 13, 2022
(86) PCT No.: PCT/CN2022/112338

§ 371 Date: Jan. 3, 2025

(51) Int. Cl. H04W 72/25; H04L 5/00; H04W 74/0808

(52) U.S. Cl. CPC H04W 72/25; H04L 5/0098; H04W 74/0808

(57) ABSTRACT

Methods, systems, and devices for wireless communications are described. A user equipment (UE) may receive a control message that indicates, to the UE, to perform wideband operations for partial sidelink messages using a carrier of an unlicensed radio frequency spectrum band. The carrier may include multiple listen-before-talk (LBT) sub-bands and the wideband operations may be associated with communications using a bandwidth that exceeds a threshold bandwidth. In some examples, the UE may perform multiple LBT procedures for the multiple LBT sub-bands and one or more LBT procedures may fail. The UE may transmit the one or more portions of the sidelink message using the one or more LBT sub-bands based on the one or more LBT procedures being associated with a first LBT sub-band different from a second LBT sub-band used for transmission of sidelink control information (SCI).

### CROSS REFERENCE

The present Application is a 371 national phase filing of International PCT Application No. PCT/CN2022/112338 by XU et al., entitled “TECHNIQUES FOR PARTIAL SIDELINK TRANSMISSION USING WIDEBAND OPERATIONS,” filed Aug. 13, 2022, which is assigned to the assignee hereof, and which is expressly incorporated by reference in its entirety herein.

### FIELD OF TECHNOLOGY

The following relates to wireless communications, including techniques for partial sidelink transmission using wideband operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some cases, a wireless communications system may support communications using an unlicensed radio frequency spectrum band.

### SUMMARY

The described techniques relate to improved methods, systems, devices, and apparatuses that support techniques for partial sidelink transmission using wideband operations. For example, the described techniques provide a framework for transmitting one or more portions of a sidelink message using one or more portions of a wideband carrier. In some examples, a user equipment (UE) may receive a control message that indicates, to the UE, to perform wideband operations for partial sidelink messages using a carrier of an unlicensed radio frequency spectrum band. The wideband operations may be associated with communications using a bandwidth that exceeds a threshold bandwidth (e.g., the wideband carrier). For example, the wideband carrier may include multiple listen-before-talk (LBT) sub-bands. In some examples, the UE may perform multiple LBT procedures for the multiple LBT sub-bands and one or more LBT procedures may fail. The UE may transmit the one or more portions of the sidelink message using the one or more LBT sub-bands based on the one or more LBT procedures being associated with a first LBT sub-band different from a second LBT sub-band used for transmission of sidelink control information (SCI).

A method for wireless communication at a UE is described. The method may include receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, performing a set of multiple LBT procedures for the set of multiple LBT sub-bands, where at least one LBT procedure of the set of multiple LBT procedures fails, and transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI.

An apparatus for wireless communication at a UE is described. The apparatus may include a processor, memory coupled with the processor, and instructions stored in the memory. The instructions may be executable by the processor to cause the apparatus to receive a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, perform a set of multiple LBT procedures for the set of multiple LBT sub-bands, where at least one LBT procedure of the set of multiple LBT procedures fails, and transmit one or more portions of a sidelink message using one or more LBT sub-bands of the set of multiple LBT sub-bands based on the at least one LBT procedure corresponding to a first LBT sub-band that is different from a second LBT sub-band used for transmission of SCI.

Another apparatus for wireless communication at a UE is described. The apparatus may include means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, means for performing a set of multiple LBT procedures for the set of multiple LBT sub-bands, where at least one LBT procedure of the set of multiple LBT procedures fails, and means for transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI.

A non-transitory computer-readable medium storing code for wireless communication at a UE is described. The code may include instructions executable by a processor to receive a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, perform a set of multiple LBT procedures for the set of multiple LBT sub-bands, where at least one LBT procedure of the set of multiple LBT procedures fails, and transmit one or more portions of a sidelink message using one or more LBT sub-bands of the set of multiple LBT sub-bands based on the at least one LBT procedure corresponding to a first LBT sub-band that is different from a second LBT sub-band used for transmission of SCI.

Some examples of the method, apparatuses, and non-transitory computer-readable medium described herein may further include operations, features, means, or instructions for performing a second set of multiple LBT procedures for the set of multiple LBT sub-bands, where an LBT procedure of the second set of multiple LBT procedures fails and refraining from transmitting a second sidelink message based on the LBT procedure corresponding to the second LBT sub-band used for transmission of the SCI.

Some examples of the method, apparatuses, and non-transitory computer-readable medium described herein may further include operations, features, means, or instructions for transmitting the SCI using a one or more sidelink control channel resources of the second LBT sub-band, where the SCI indicates or more respective sidelink shared channel resources of the one or more LBT sub-bands for the one or more portions of the sidelink message.

In some examples of the method, apparatuses, and non-transitory computer-readable medium described herein, the second LBT sub-band corresponds to a lowest set of frequencies of a set of multiple sets of frequencies associated with the set of multiple LBT sub-bands and a sidelink control channel resource of the one or more sidelink control channel resources correspond to a lowest frequency of the second LBT sub-band.

In some examples of the method, apparatuses, and non-transitory computer-readable medium described herein, transmitting the one or more portions of the sidelink message may include operations, features, means, or instructions for transmitting respective portions of the sidelink message using respective LBT sub-bands of the one or more LBT sub-bands, where the respective LBT sub-bands correspond to successful LBT procedures.

A method for wireless communication at a UE is described. The method may include receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, performing a set of multiple LBT procedures for the set of multiple LBT sub-bands, where at least one LBT procedure of the set of multiple LBT procedures fails, transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations, and transmitting the portion of the sidelink message using the one or more frequency resources.

An apparatus for wireless communication at a UE is described. The apparatus may include a processor, memory coupled with the processor, and instructions stored in the memory. The instructions may be executable by the processor to cause the apparatus to receive a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, perform a set of multiple LBT procedures for the set of multiple LBT sub-bands, where at least one LBT procedure of the set of multiple LBT procedures fails, transmit SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations, and transmit the portion of the sidelink message using the one or more frequency resources.

Another apparatus for wireless communication at a UE is described. The apparatus may include means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, means for performing a set of multiple LBT procedures for the set of multiple LBT sub-bands, where at least one LBT procedure of the set of multiple LBT procedures fails, means for transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations, and means for transmitting the portion of the sidelink message using the one or more frequency resources.

A non-transitory computer-readable medium storing code for wireless communication at a UE is described. The code may include instructions executable by a processor to receive a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth, perform a set of multiple LBT procedures for the set of multiple LBT sub-bands, where at least one LBT procedure of the set of multiple LBT procedures fails, transmit SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations, and transmit the portion of the sidelink message using the one or more frequency resources.

Some examples of the method, apparatuses, and non-transitory computer-readable medium described herein may further include operations, features, means, or instructions for receiving a second control message that indicates, to the UE, one or more rules for indicating the one or more frequency resources of the LBT sub-band using the SCI, where the SCI may be transmitted based on the second control message.

In some examples of the method, apparatuses, and non-transitory computer-readable medium described herein, transmitting the SCI may include operations, features, means, or instructions for transmitting a quantity of bits that indicates the one or more frequency resources, where the quantity of bits may be based on the wideband operations and a frequency resource indicator value associated with the one or more frequency resources.

In some examples of the method, apparatuses, and non-transitory computer-readable medium described herein, transmitting the SCI may include operations, features, means, or instructions for transmitting a first SCI message including an indication of a quantity of contiguous frequency resources including the one or more frequency resources and transmitting a second SCI message including an indication of a frequency location of a frequency resource of the quantity of contiguous frequency resources, where the frequency location may be relative to a lowest frequency of a set of frequencies associated with the LBT sub-band.

In some examples of the method, apparatuses, and non-transitory computer-readable medium described herein, the frequency location of the frequency resource may be indicated using one or more bits that correspond to an index associated with the frequency resource.

In some examples of the method, apparatuses, and non-transitory computer-readable medium described herein, the frequency location of the frequency resource may be indicated using one or more bits that correspond to a status of the LBT procedure corresponding to the LBT sub-band.

In some examples of the method, apparatuses, and non-transitory computer-readable medium described herein, transmitting the SCI may include operations, features, means, or instructions for scrambling a portion of bits included in the SCI, where the one or more frequency resources may be indicated based on the scrambled portion of bits.

In some examples of the method, apparatuses, and non-transitory computer-readable medium described herein, the scrambled portion of bits include CRC bits.

In some examples of the method, apparatuses, and non-transitory computer-readable medium described herein, the portion of bits may be scrambled using an RNTI and the one or more frequency resources may be indicated based on the RNTI and an index associated with the LBT sub-band.

Some examples of the method, apparatuses, and non-transitory computer-readable medium described herein may further include operations, features, means, or instructions for transmitting second SCI using the LBT sub-band, the second SCI indicating that the portion of the sidelink message may be transmitted using the wideband operations.

A method for wireless communication at a network entity is described. The method may include transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth and transmitting a second control message that indicates, to the UE, one or more rules for identifying frequency resources of the set of multiple LBT sub-bands in which the partial sidelink messages are to be transmitted.

An apparatus for wireless communication at a network entity is described. The apparatus may include a processor, memory coupled with the processor, and instructions stored in the memory. The instructions may be executable by the processor to cause the apparatus to transmit a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth and transmit a second control message that indicates, to the UE, one or more rules for identifying frequency resources of the set of multiple LBT sub-bands in which the partial sidelink messages are to be transmitted.

Another apparatus for wireless communication at a network entity is described. The apparatus may include means for transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth and means for transmitting a second control message that indicates, to the UE, one or more rules for identifying frequency resources of the set of multiple LBT sub-bands in which the partial sidelink messages are to be transmitted.

A non-transitory computer-readable medium storing code for wireless communication at a network entity is described. The code may include instructions executable by a processor to transmit a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth and transmit a second control message that indicates, to the UE, one or more rules for identifying frequency resources of the set of multiple LBT sub-bands in which the partial sidelink messages are to be transmitted.

In some examples of the method, apparatuses, and non-transitory computer-readable medium described herein, transmitting the second control message may include operations, features, means, or instructions for transmitting an indication of a rule of the one or more rules that indicates, to the UE, to identify the frequency resources using a quantity of bits transmitted using SCI, where the quantity of bits may be based on the wideband operations and a frequency resource indicator value associated with the frequency resources.

In some examples of the method, apparatuses, and non-transitory computer-readable medium described herein, transmitting the second control message may include operations, features, means, or instructions for transmitting an indication of a rule of the one or more rules that indicates, to the UE, to identify the frequency resources using a first SCI message that includes an indication of a quantity of contiguous frequency resources including the frequency resources and a second SCI message including an indication of a frequency location of a frequency resource of the quantity of contiguous frequency resources, where the frequency location may be relative to a lowest frequency of a set of frequencies associated with an LBT sub-band of the set of multiple LBT sub-bands.

In some examples of the method, apparatuses, and non-transitory computer-readable medium described herein, the rule further indicates that the frequency location of the frequency resource may be identified using one or more bits that correspond to an index associated with the frequency resource.

In some examples of the method, apparatuses, and non-transitory computer-readable medium described herein, the rule further indicates that the frequency location of the frequency resource may be identified using one or more bits that correspond to a status of an LBT procedure corresponding to the LBT sub-band.

In some examples of the method, apparatuses, and non-transitory computer-readable medium described herein, transmitting the second control message may include operations, features, means, or instructions for transmitting an indication of a rule of the one or more rules that indicates, to the UE, to identify the frequency resources using a portion of bits that may be scrambled and included in a SCI message.

In some examples of the method, apparatuses, and non-transitory computer-readable medium described herein, the rule further indicates that the portion of bits include CRC bits.

In some examples of the method, apparatuses, and non-transitory computer-readable medium described herein, the rule further indicates that the portion of bits may be scrambled using an RNTI and the frequency resources may be indicated based on the RNTI and an index associated with a respective LBT sub-band of the set of multiple LBT sub-bands.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports techniques for partial sidelink transmission using wideband operations in accordance with one or more aspects of the present disclosure.

FIG. 2 illustrates an example of a network architecture that supports techniques for partial sidelink transmission using wideband operations in accordance with one or more aspects of the present disclosure.

FIG. 3 illustrates an example of a wireless communications system that supports techniques for partial sidelink transmission using wideband operations in accordance with one or more aspects of the present disclosure.

FIGS. 4 through 6, 7A, and 7B each illustrates an example of a wideband carrier diagram that supports techniques for partial sidelink transmission using wideband operations in accordance with one or more aspects of the present disclosure.

FIG. 8 illustrates an example of a process flow that supports techniques for partial sidelink transmission using wideband operations in accordance with one or more aspects of the present disclosure.

FIGS. 9 and 10 show block diagrams of devices that support techniques for partial sidelink transmission using wideband operations in accordance with one or more aspects of the present disclosure.

FIG. 11 shows a block diagram of a communications manager that supports techniques for partial sidelink transmission using wideband operations in accordance with one or more aspects of the present disclosure.

FIG. 12 shows a diagram of a system including a device that supports techniques for partial sidelink transmission using wideband operations in accordance with one or more aspects of the present disclosure.

FIGS. 13 and 14 show block diagrams of devices that support techniques for partial sidelink transmission using wideband operations in accordance with one or more aspects of the present disclosure.

FIG. 15 shows a block diagram of a communications manager that supports techniques for partial sidelink transmission using wideband operations in accordance with one or more aspects of the present disclosure.

FIG. 16 shows a diagram of a system including a device that supports techniques for partial sidelink transmission using wideband operations in accordance with one or more aspects of the present disclosure.

FIGS. 17 through 19 show flowcharts illustrating methods that support techniques for partial sidelink transmission using wideband operations in accordance with one or more aspects of the present disclosure.

### DETAILED DESCRIPTION

Some wireless communications systems may include communication devices, such as user equipments (UEs) or network entities, that support wireless communications using one or more radio access technologies (RATs). For example, the communication devices may support wireless communications using one or multiple cellular RATs, such as fourth generation (4G) systems (e.g., Long Term Evolution (LTE) systems), and fifth generation (5G) systems, which may be referred to as New Radio (NR) systems. In some examples, the wireless communications system may support communications using an unlicensed radio frequency spectrum band that may be shared with one or more other RATs, such as Wi-Fi, or Bluetooth, or both, among other examples. In such examples, prior to transmitting communications using the unlicensed radio frequency spectrum band, a communication device (e.g., a network entity, a UE) may perform a channel access procedure, such as to gain access to a communication channel (e.g., frequency resources) of the unlicensed radio frequency spectrum band. The communication device may support wideband operations in which a carrier (e.g., a wideband carrier) of the unlicensed radio frequency spectrum band may include multiple bandwidths. In some examples, the communication device may perform wideband operations using a network access link (e.g., a Uu interface). In such examples, the communication device may perform a channel access procedure for multiple bandwidth of the carrier and may transmit communications using bandwidths in which the respective channel access procedure is successful.

In some other examples, the communication device may perform wideband operations using a sidelink (e.g., a PC5 interface). In such examples, the communication device may transmit sidelink control information (SCI) that may include information regarding resource allocation for subsequent sidelink transmissions (e.g., data transmissions). For example, the SCI may include an indication (e.g., a reservation announcement) of one or more resources that the UE may intend to use (e.g., may have reserved) for transmitting one or more portions of sidelink message using one or more bandwidths of the carrier. In some examples, the communication device may use a particular bandwidth of the wideband carrier to transmit the SCI. As such, if a channel access procedure performed for the bandwidth in which the SCI is to be transmitted fails, the SCI may not be transmitted at the communication device. In such examples, another communication device (e.g., a receiving device) may be incapable of determining which resources are to be used at the communication device for transmitting the one or more portions of the sidelink message.

Various aspects of the present disclosure generally relate to techniques for partial sidelink transmission using wideband operations, and more specifically, to a framework for transmitting one or more portions of a sidelink message using one or more portions of a wideband carrier. For example, a communication device may be configured with one or more rules for performing wideband operations using an unlicensed sidelink channel (e.g., a sidelink channel of the unlicensed radio frequency spectrum band). In some examples, the communication device may be configured to transmit a sidelink communication (e.g., a sidelink message or one or more portions of a sidelink message) using a bandwidth of the wideband carrier if a channel access procedure associated with the bandwidth, and a bandwidth used for transmitting SCI (e.g., a same bandwidth or another bandwidth) is successful. That is, the communication device may transmit one or more sidelink communications using one or more bandwidths of the wideband carrier if the communication device is capable of transmitting the SCI.

Additionally, or alternatively, the communication device may transmit (e.g., flexibly transmit) the SCI based on successful channel access procedures. For example, the communication device may transmit SCI using one or more bandwidths (e.g., each bandwidth) in which an associated channel access is successful. In such an example, the network may configure the communication device (e.g., or the communication device may be otherwise configured) to indicate resource allocation information (e.g., of subsequent sidelink communications) using a particular quantity of bits, a cyclic redundancy check (CRC) mask, or a scrambling identifier (ID) included in a first type of SCI. Additionally, or alternatively, the communication device may be configured (e.g., from the network or otherwise) to indicate the resource allocation information using a bit map included in a second type of SCI.

Particular aspects of the subject matter described herein may be implemented to realize one or more of the following potential advantages. The techniques employed by the described communication devices may provide benefits and enhancements to the operation of the communication devices, including enabling partial sidelink transmissions using a wideband carrier of an unlicensed radio frequency spectrum band. Further, techniques for partial sidelink transmission using wideband operations, as described herein, may support increased data rates, one or more spectrum efficiency enhancements, and increased resource utilization, thereby improving throughput and reliability within a wireless communications system. Such techniques may lead to improved network operations and network work efficiencies, among other possible benefits.

Aspects of the disclosure are initially described in the context of wireless communications systems. Aspects of the disclosure are also described in the context of a network architecture, wideband carrier diagrams, and a process flow. Aspects of the disclosure are further illustrated by and described with reference to apparatus diagrams, system diagrams, and flowcharts that relate to techniques for partial sidelink transmission using wideband operations.

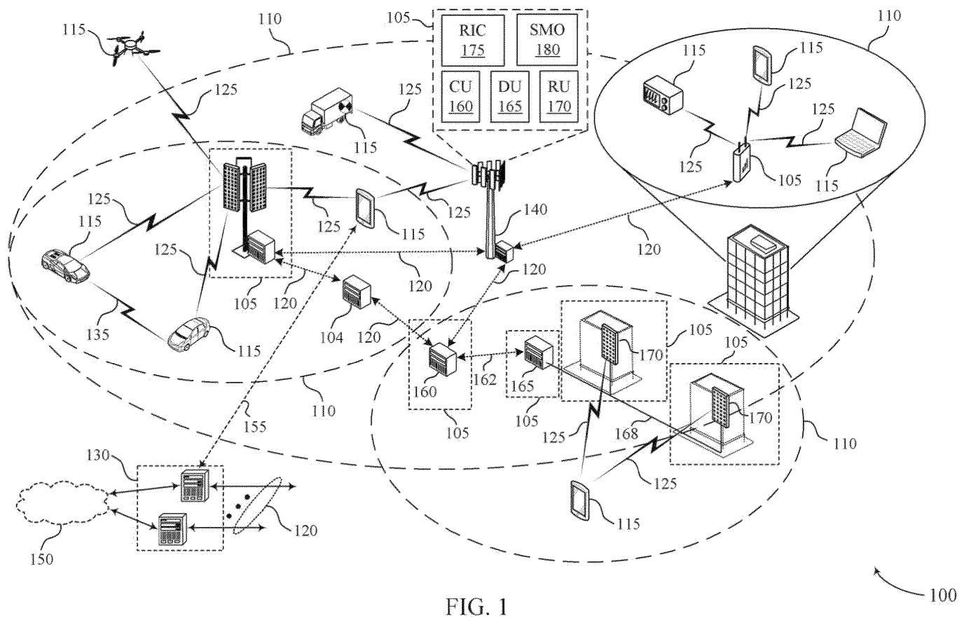

FIG. 1 illustrates an example of a wireless communications system 100 that supports techniques for partial sidelink transmission using wideband operations in accordance with one or more aspects of the present disclosure. The wireless communications system 100 may include one or more network entities 105, one or more UEs 115, and a core network 130. In some examples, the wireless communications system 100 may be an LTE network, an LTE-Advanced (LTE-A) network, an LTE-A Pro network, an NNR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for partial sidelink transmission using wideband operations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support a framework for transmitting one or more portions of a sidelink message using one or more portions of a wideband carrier. For example, a UE 115 may receive a control message that indicates, to the UE 115, to perform wideband operations for partial sidelink messages using a carrier of an unlicensed radio frequency spectrum band (e.g., a wideband carrier). In some examples, the wideband carrier may include multiple listen-before-talk (LBT) sub-bands. Additionally, or alternatively, in some examples, the wideband operations may be associated with communications (e.g., sidelink communications or any other type of communications) using a bandwidth that exceeds the threshold bandwidth (e.g., 20 MHz, 40 MHz, 60 MHz). In some examples, the UE 115 may perform multiple LBT procedures for the multiple LBT sub-bands, for example to gain access to a sidelink channel of the unlicensed radio frequency spectrum band for sidelink communications. In some examples, one or more LBT procedures (e.g., of the multiple LBT procedures) may fail. In such examples, the UE 115 may transmit one or more partial sidelink messages using one or more LBT sub-bands based on the one or more LBT procedures being associated with a first LBT sub-band that is different from a second LBT sub-band used for transmission of SCI.

In some examples, the UE 115 may transmit SCI using one or more LBT sub-bands based on LBT procedures associated with the LBT sub-bands being successful. In some examples, the SCI may indicate one or more frequency resources of one or more the LBT sub-bands to be used for transmitting one or more portions of a sidelink message. The one or more frequency resources may be based on the wideband operations. In some examples, the UE 115 may transmit the one or more portions of the sidelink message to another UE 115 (e.g., a receiving UE) using the one or more frequency resources (e.g., indicated using the SCI). In some examples, transmitting SCI using LBT sub-bands in which the associated LBT procedure is successful may lead to increased resource utilization within the wireless communications system 100, among other possible benefits.

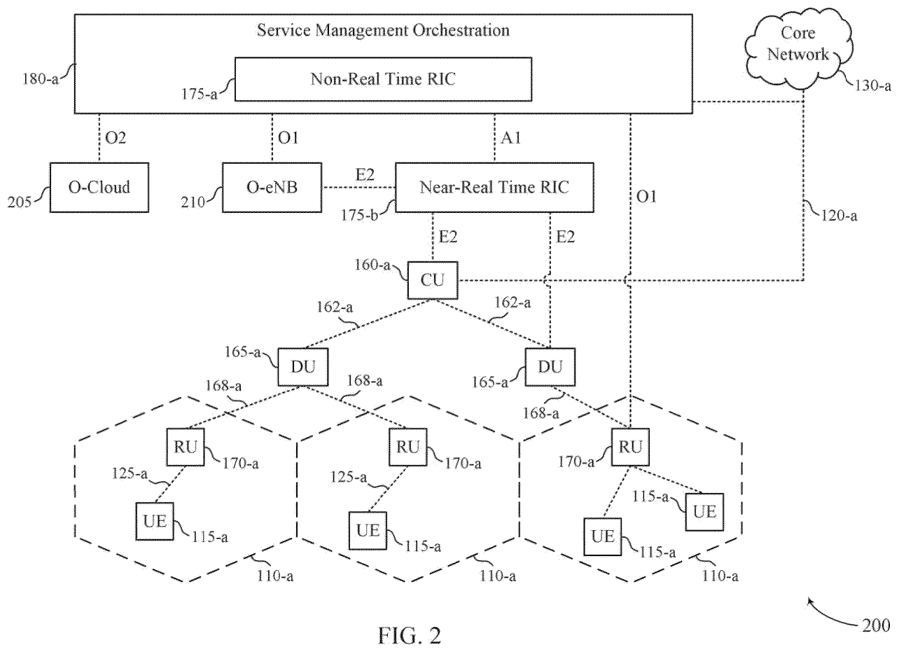

FIG. 2 illustrates an example of a network architecture 200 (e.g., a disaggregated base station architecture, a disaggregated RAN architecture) that supports techniques for partial sidelink transmission using wideband operations in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The network architecture 200 may support techniques for partial sidelink transmission using wideband operations. In some examples, a network entity (e.g., a CU 160-a, a DU 165-a, an RU 170-a or the like) may configure one or more UEs 115-a for wideband operations using an unlicensed radio frequency spectrum band. For example, the network entity may transmit control signaling, such as RRC signaling, that indicates, to the UEs 115-a, to perform wideband operations for partial sidelink messages using a carrier of an unlicensed radio frequency spectrum band (e.g., a wideband carrier). Additionally, or alternatively, the network entity may configure the UEs 115 with one or more rules for indicating (e.g., to other UEs 115-a) resource allocation information (e.g., frequency resource allocation information) associated with partial sidelink transmissions (e.g., using the wideband carrier). For example, the network entity may configure the UEs 115-a to indicate frequency resource allocation information using a particular quantity of bits, a CRC mask, or a scrambling ID included in a first type of SCI. Additionally, or alternatively, the network entity may configure the UEs 115-a to indicate the frequency resource allocation information using a bit map included in a second type of SCI. In some examples, configuring the UEs 115-a with one or more rules for performing partial sidelink transmissions using a wideband carrier may lead to increased reliability of communications between the network entity and the UEs 115-a, among other possible benefits.

In some examples, the aforementioned operations of the network entity (e.g., a CU 160-a, a DU 165-a, an RU 170-a) may be performed in accordance with the network architecture 200. For example, higher layer parameters (e.g., RRC parameters) indicative of the wideband operations (e.g., indicative of the one or more rules for partial sidelink transmissions using a wideband carrier) may be determined (e.g., selected, configured) by the CU 160-a and communicated to the DU 165-a (e.g., via a midhaul communication link 162-a). In some examples, the DU 165-a may execute control signaling (e.g., RRC signaling) according to the parameters (or other rules associated with wideband communications, or sidelink communications, or both) communicated to the DU 165-a from the CU 160-a (e.g., via the higher layer parameters). For example, the DU 165-a may generate a control signal used to indicate the parameters to the one or more UEs 115-a. The DU 165-a may communicate the control signal (or one or more aspects of the control signal) to the RU 170-a, for example via a fronthaul communication link 168-a. In some examples, and in response to obtaining the control signal generated by the DU 165-a, the RU 170-a may transmit the control signal (e.g., OTA) to the one or more UEs 115-a via a communication link 125-a. Such techniques may lead to increased reliability of wireless communications between the UEs 115-a and the network.

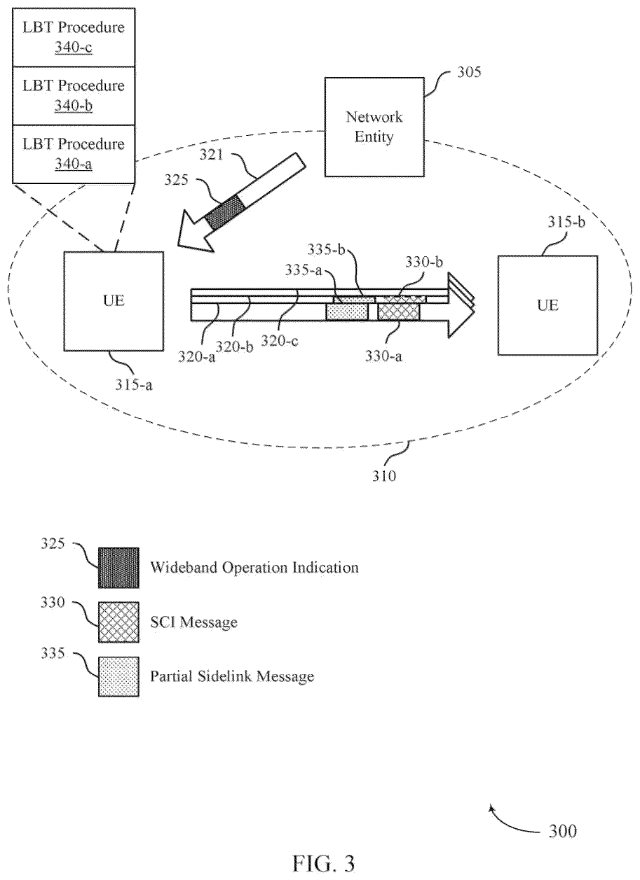

FIG. 3 illustrates an example of a wireless communications system 300 that supports techniques for partial sidelink transmission using wideband operations in accordance with one or more aspects of the present disclosure. In some examples, the wireless communications system 300 may implement aspects of the wireless communications system 100 and the network architecture 200. For example, the wireless communications system 300 may include a network entity 305, a UE 315-a, and a UE 315-b, which may be examples of the corresponding devices as described with reference to FIGS. 1 and 2. The network entity 305 and the UEs 315 may communicate within a coverage area 310, which may be an example of a coverage area 110 described with reference to FIG. 1 or 2.

The wireless communications system 300 may support wireless communications using an unlicensed (e.g., shared) radio frequency spectrum. For example, to transmit a communication using the unlicensed radio frequency spectrum, a communication device (e.g., the UE 315-a, the UE 315-b, the network entity 305) may perform a channel access procedure (e.g., a clear channel access procedure (CCA)) to gain access to a communication channel of the unlicensed radio frequency spectrum during a duration. In such an example, the communication device may transmit the communication in response to successfully completing the CCA procedure. Additionally, or alternatively, the communication device may refrain from transmitting the communication in response the CCA procedure failing.

In some examples, the wireless communications system 300 may support wideband operations using the unlicensed radio frequency spectrum. For example, the network entity 305 (e.g., a gNB) may transmit partial downlink messages (e.g., partial physical downlink shared channel (PDSCH) messages) to the UE 315-a or the UE 315-b (or both) using wideband operations. In such an example, the UE 315-a or the UE 315-b (or both) may perform one or more default operations (e.g., non-wideband operations). As described herein, wideband operations may refer to communications using a bandwidth (e.g., a set of radio frequencies) that exceeds a threshold bandwidth (e.g., about 100 MHz or some other suitable bandwidth). Additionally, or alternatively, as described herein, a bandwidth (e.g., a set of frequencies that exceeds the threshold bandwidth) may be referred to as a wideband carrier. In some examples, the network entity 305 may transmit a PDSCH message using a wideband carrier (e.g., across a single active bandwidth) or using one or more portions of the wideband carrier in which a CCA procedure, such as an LBT procedure, may be successful (e.g., at the network entity 305).

For example, a wideband carrier may include multiple portions (e.g., different portions, such as different bandwidth parts) and each portion may be associated with an LBT procedure. That is, the network entity 305 (or another communication device) may transmit a portion of the PDSCH message (e.g., a partial PDSCH message) using a portion of a wideband carrier if an LBT procedure associated with the portion of the wideband carrier is successful. In some examples, the UE 315-a or the UE 315-b (or both) may receive the PDSCH message (e.g., scheduled to be transmitted from the network entity 305) using the wideband carrier or one or more portions of the wideband carrier. As described herein, a portion of a wideband carrier (e.g., that may be associated with an LBT procedure) may be referred to as an LBT sub-band. Although an LBT sub-band is referred to throughout the disclosure, it is to be understood that the techniques described herein may also apply to other sets of frequencies, such as other bandwidths, sub-bands, or carriers, and the examples described herein should not be considered limiting to the scope covered by the claims or the disclosure.

In some examples, the UE 315-a or the UE 315-b (or both) may be scheduled to transmit an uplink message (e.g., a physical uplink shared channel (PUSCH) message) to the network entity 305 using a wideband carrier. In such examples, the UE 315-a or the UE 315-b (or both) may transmit the PUSCH message using the wideband carrier (e.g., of the scheduled PUSCH message), for example if LBT procedures (e.g., each LBT procedure) associated with the LBT sub-bands are successful. That is, the UE 315-a or the UE 315-b (or both) may refrain from transmitting the PUSCH message (e.g., one or more portions of the PUSCH message) if an LBT procedure associated with one or more LBT sub-bands of the wideband carrier fails. In some examples, the network entity 305 may refrain from transmitting (e.g., and the UE 315-a or the UE 315-b may not expect to receive) resource allocations in discontinuous LBT sub-bands within the wideband carrier.

Additionally, or alternatively, the wireless communications system 300 may support V2X communications. For example, one or both of the UE 315-a and the UE 315-b may be examples of vehicles. In some examples of V2X communications (or other types of sidelink communications), frequency domain allocations (e.g., allocation of communication resources in the frequency domain, allocation of frequency resources) may be indicated using SCI (e.g., SCI format 1). For example, a resource allocation unit in the frequency domain may include a sub-channel. Additionally, or alternatively, a sub-channel assignment for a sidelink transmission may be determined (e.g., at the UE 315-a and the UE 315-b) using a frequency resource assignment field (e.g., a frequency domain resource assignment (FDRA) field) in an associated SCI. In some examples, the FDRA may provide a frequency resource indication value (FRIV) associated with the sidelink transmission (e.g., a PSSCH transmission). That is, one or more frequency domain resources for transmission of the PSSCH message may be determined using an SCI (e.g., transmitted using a PSCCH) associated with the PSSCH message (e.g., associated with a PSSCH used for transmission of the PSSCH message).

In some examples, a relatively lowest sub-channel, of multiple sub-channels to be used for a sidelink transmission (e.g., transmission of a PSSCH message), may be associated with a sub-channel used for transmission of a PSCCH message that may include SCI associated with the PSSCH message. For example, the relatively lowest sub-channel may correspond to a relatively lowest resource (e.g., a physical resource block (PRB) including a relatively lowest frequency of multiple frequencies included in the multiple sub-channels) of multiple resources in which the associated PSCCH message may be transmitted. That is, one or more resources (e.g., one or more frequency domain resources) to be used for transmission of a PSSCH message may be determined based on (e.g., relative to) one or more resources used for transmission of the PSCCH message including the SCI (e.g., indicating an FRIV for the PSSCH message). In such an example, a quantity of sub-channels allocated for transmission of the PSSCH message (e.g., contiguously allocated sub-channels) may be determined based on a quantity of resources reserved (e.g., at the UE 315-a or the UE 315-b) for transmission of the PSSCH message (e.g., including the one or more resources) and the FDRA field (e.g., indicating the FRIV).

For example, such as an example in which two resources (e.g., up to about two time domain resources) may be reserved (e.g., as may be indicated using a sl-MaxNumPerReserve information element (IE)), the FDRA field may indicate (e.g., cover) a beginning (e.g., starting) sub-channel for a second resource (e.g., a second resource of the two resources reserved for transmission of the PSSCH message) and a quantity of sub-channels included in a first resource and the second resource (e.g., both of the resources reserved for transmission of the PSSCH message). In some examples, such as examples in which three resources (e.g., up to about three time domain resources) may be reserved (e.g., as may be indicated using the sl-MaxNumPerReserve IE), the FDRA field may indicate a beginning sub-channel for a second resource (e.g., a second resource of the three resources reserved for transmission of the PSSCH message), a beginning sub-channel for a third resource (e.g., a third resource of the three resources reserved for transmission of the PSSCH message) and a quantity of sub-channels included in a first resource, the second resource, and the third resource (e.g., each of the three resources reserved for transmission of the PSSCH message). In such examples (e.g., examples in with two or three resources may be reserved for transmission of the PSSCH message), the first resource may correspond to the relatively lowest resource (e.g., the PRB including the relatively lowest frequency of the multiple frequencies included in the reserved resources). That is, the relatively lowest sub-channel for the PSSCH transmission may correspond to a sub-channel in which the relatively lowest PRB of the associated PSCCH message (e.g., including the SCI) may be transmitted. It is to be understood that the names of IEs described herein may change based on implementation of one or more devices (e.g., the UE 315-a, the UE 315-b, or the network entity 305, or any combination thereof), and the examples described herein should not be considered limiting to the scope covered by the claims or the disclosure.

As illustrated in the example of FIG. 3, the wireless communications system 300 may support wideband operations for sidelink communications using the unlicensed radio frequency spectrum band. For example, such as an example in which a carrier (e.g., a wideband carrier) includes multiple LBT sub-bands 320 (e.g., 20 MHz bandwidths in the 5 GHz or 6 GHz unlicensed radio frequency spectrum band), the wireless communications system 300 may support sidelink communications using the wideband carrier (e.g., using bandwidths up to 100 MHz with 30 kHz subcarrier spacing (SCS)). In such examples, the UE 315-a may perform multiple LBT procedures 340 to gain access to the channel for sidelink transmissions, such as a sidelink transmission using the PSCCH (e.g., a PSCCH message including an SCI message 330) and one or more partial sidelink transmissions using the PSSCH (e.g., a partial sidelink message 335-a, a partial sidelink message 335-b), using one or more LBT sub-bands 320 (e.g., an LBT sub-band 320-a, an LBT sub-band 320-b, an LBT sub-band 320-c).

In some examples, one or more of the LBT procedures 340 associated with the LBT sub-bands 320 may fail. For example, the LBT sub-band 320-a may include the relatively lowest PRB of multiple PRBs included the PSSCH (e.g., the PRB in which the SCI message 330 may be transmitted) and, in some examples, an LBT procedure 340-a associated with the LBT sub-band 320-a may fail. In such an example, if the UE 315-a (e.g., a transmitting communication device) transmits one or more portions of a PSSCH message using other LBT sub-band (e.g., LBT sub-bands in which the associated LBT procedure was successful) the UE 315-b (e.g., a receiving communication device) may fail to receive the SCI message 330-a (e.g., due to the LBT procedure 340-a associated with the LBT sub-band 320-a failing). In some examples, if the UE 315-b fails to receive the SCI message 330-a, the UE 315-b may be incapable of determining a frequency location of the partial sidelink messages 335 (e.g., a starting position of resources reserved for the partial sidelink messages 335, a starting sub-channel of resources reserved for the partial sidelink messages 335).

In some examples, techniques for partial sidelink transmissions using wideband operations, as described herein, may provide one or more enhancements for transmission of partial sidelink messages (e.g., one or more portions of a sidelink message, one or more portions of a PSSCH message) using one or more LBT sub-bands. For example, some techniques for partial sidelink transmissions using wideband operations, as described herein, may enable transmission of one or more portions of a PSSCH message based on an LBT procedure corresponding to a relatively lowest PRB of an associated PSSCH (e.g., a PSSCH to be used for transmission of the PSSCH message). Additionally, or alternatively, some techniques for partial sidelink transmissions using wideband operations, as described herein, may enable decoupling of PSSCH frequency allocation with PSCCH frequency location. That is, such techniques may provide for the determination of resources (e.g., frequency domain resources) to be used for transmission of a PSSCH message or one or more portions of a PSSCH message irrespective of a frequency location of an associated PSCCH (e.g., a PSCCH used to transmit a PSCCH message including SCI).

For example, as illustrated in the example of FIG. 3, the UE 315-a may receive a control message from the network entity 305 (e.g., using the carrier 321). The control message may include a wideband operation indication 325 that indicates, to the UE 315-a, to perform wideband operations for partial sidelink messages using a carrier of an unlicensed radio frequency spectrum band (e.g., a wideband carrier). In some examples, the wideband carrier may include multiple LBT sub-bands. For example, the wideband carrier may include the LBT sub-band 320-a, the LBT sub-band 320-b, and the LBT sub-band 320-c (e.g., and one or more other sub-bands). Additionally, or alternatively, in some examples, the wideband operations may be associated with communications (e.g., sidelink communications or any other type of communications) using a bandwidth that exceeds the threshold bandwidth (e.g., about 100 MHz or some other suitable bandwidth). In some examples, the UE 315-a may perform multiple LBT procedures for the multiple LBT sub-bands (e.g., for the LBT sub-band 320-a, the LBT sub-band 320-b, and the LBT sub-band 320-c). For example, the UE 315-a may perform the LBT procedure 340-a that may be associated with the LBT sub-band 320-a, an LBT procedure 340-b that may be associated with the LBT sub-band 320-b, and an LBT procedure 340-c that may be associated with the LBT sub-band 320-c.

In some examples, one or more LBT procedures (e.g., of the multiple LBT procedures) may fail. For example, the LBT procedure 340-c (e.g., associated with the LBT sub-band 320-c) may fail. In such examples, the UE 315-a may transmit one or more partial sidelink messages 335 using one or more LBT sub-bands (e.g., of the multiple LBT sub-bands). For example, the UE 315-a may transmit, to the UE 315-b, a partial sidelink message 335-a using the LBT sub-band 320-a and a partial sidelink message 335-b using the LBT sub-band 320-b. In some examples, the UE 315-a may transmit the partial sidelink message 335-a and the partial sidelink message 335-b based on the SCI message 330-a (e.g., an SCI message associated with the partial sidelink message 335-a, the partial sidelink message 335-b, and one or more other partial sidelink messages) being transmitted using the LBT sub-band 320-a (e.g., using a PSCCH associated with the LBT sub-band 320-a). That is, the UE 315-a may transmit the partial sidelink message 335-a and the partial sidelink message 335-b based on the LBT procedure 340-c (e.g., the LBT procedure that failed) being associated with the LBT sub-band 320-c (e.g., an LBT sub-band different from the LBT sub-band 320-a used for transmission of the SCI message 330-a).

In some examples, the UE 315-a may transmit the SCI message 330-a and the SCI message 330-b based on the LBT procedure 340-a and the LBT procedure 340-b being successful. The SCI message330-a may indicate one or more frequency resources of the LBT sub-band 320-a to be used for transmitting the partial sidelink message 335-a and the SCI message 330-b may indicate one or more frequency resources of the LBT sub-band 320-b to be used for transmitting the partial sidelink message 335-b. The one or more frequency resources (e.g., of the LBT sub-band 320-a and the LBT sub-band 320-b, respectively) may be based on the wideband operations. In some examples, the UE 315-a may transmit, to the UE 315-b, the partial sidelink message 335-a using the one or more frequency resources indicated using the SCI message 330-a and the partial sidelink message 335-b using the one or more frequency resources indicated using the SCI message 330-b. In some examples, transmitting the SCI message 330-a and the SCI message 330-b based on the LBT procedure 340-a and the LBT procedure 340-b being successful may improve throughput and reliability within the wireless communications system 300.

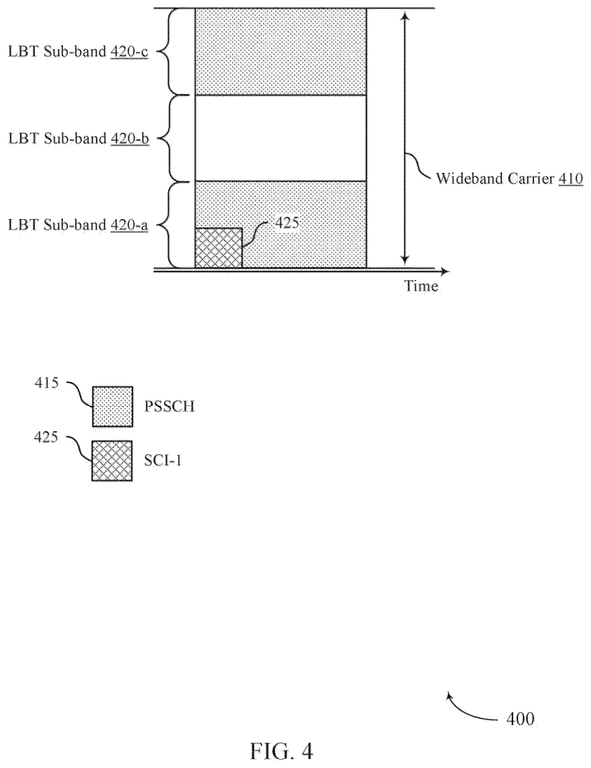

FIG. 4 illustrates an example of a wideband carrier diagram 400 that supports techniques for partial sidelink transmission using wideband operations in accordance with one or more aspects of the present disclosure. In some examples, the wideband carrier diagram 400 may implement aspects of the wireless communications system 100, the network architecture 200, and the wireless communications system 300. For example, the wideband carrier diagram 400 may be implemented at a network entity or a UE, or both, which may be examples of the corresponding devices as described with reference to FIGS. 1 through 3.

In some examples, a wireless communications system may support wideband operations for sidelink communications using the unlicensed radio frequency spectrum band. For example, the wireless communications system may support sidelink communications using a wideband carrier 410 that includes multiple LBT sub-bands (e.g., an LBT sub-band 420-a, an LBT sub-band 420-b, and an LBT sub-band 420-c). In such examples, a first UE may perform multiple LBT procedures to gain access to the channel for sidelink transmissions using the multiple LBT sub-bands. For example, the first UE may perform a first LBT procedure associated with the LBT sub-band 420-a, a second LBT procedure for the LBT sub-band 420-b, and a third LBT procedure for LBT sub-band 420-c. In some examples, the LBT sub-band 420-a may be used to transmit SCI-1 425. In the example of FIG. 4, the SCI-1 425 may correspond to first type of SCI (e.g., SCI format 1). For example, the LBT sub-band 420-a with SCI-1 425 (e.g., a primary LBT bandwidth) may corresponds to a relatively lowest PRB (e.g., may include a PRB with a relatively lowest frequency of multiple frequencies included in the wideband carrier 410). In some examples, the relatively lowest PRB may be associated with a PSSCH 415 (e.g., a physical channel including one or more time-frequency resources for sidelink data transmissions). For example, the relatively lowest PRB may be used to transmit the SCI-1 425, which may be associated with (e.g., include resource allocation information for) the PSSCH 415.

In some examples, the first LBT procedure (e.g., the LBT procedure associated with the LBT sub-band 420-a, an LBT procedure associated with the primary LBT bandwidth) may fail. In such examples, the first UE may refrain from transmitting (e.g., may drop) one or more portions of a PSSCH message (e.g., one or more portions of a message to be transmitted using the PSSCH 415). Additionally, or alternatively, as illustrated in the example of FIG. 4, the first UE may successfully complete the first LBT procedure (e.g., the first LBT procedure may be successful, the primary LBT bandwidth may pass the associated LBT procedure). In such an example, the first UE may transmit, to a second UE, the SCI-1 425. In some examples, the first UE may transmit the SCI-1 425 using a sidelink control channel (e.g., a PSCCH). In some examples, the SCI-1 425 may be used (e.g., in accordance with one or more default procedures) to determine a frequency resource allocation of the PSSCH 415. That is, the second UE may use the SCI-1 425 to determine one or more frequency resources of the PSSCH 415 to be used (e.g., at the first UE) for transmission of one or more portions of a PSSCH message. For example, the SCI-1 425 may include a FDRA field that may indicate, to the second UE, a portion (e.g., one or more frequency resources) of the PSSCH 415 associated with the LBT sub-band 420-a and a portion of the PSSCH 415 associated with the LBT sub-band 420-c to be used for transmitting one or more portions of the PSSCH message.

The first UE may transmit one or more portions of the PSSCH message using the indicated frequency resources (e.g., the indicated portions of the PSSCH 415), for example in the LBT sub-bands in which the associated LBT procedure was successful. For example, the first UE may transmit one or more portions of the PSSCH message using the LBT sub-band 420-a and the LBT sub-band 420-c based on the first and third LBT procedures being successful and may refrain from transmitting a portion of the PSSCH message using the LBT sub-band 420-b based on the second LBT procedure failing. In some examples, transmitting one or more portions of the PSSCH message using the LBT sub-band 420-a and the LBT sub-band 420-c based on the first and third LBT procedures being successful may increase the resource utilization between the first UE and the second UE, among other benefits.

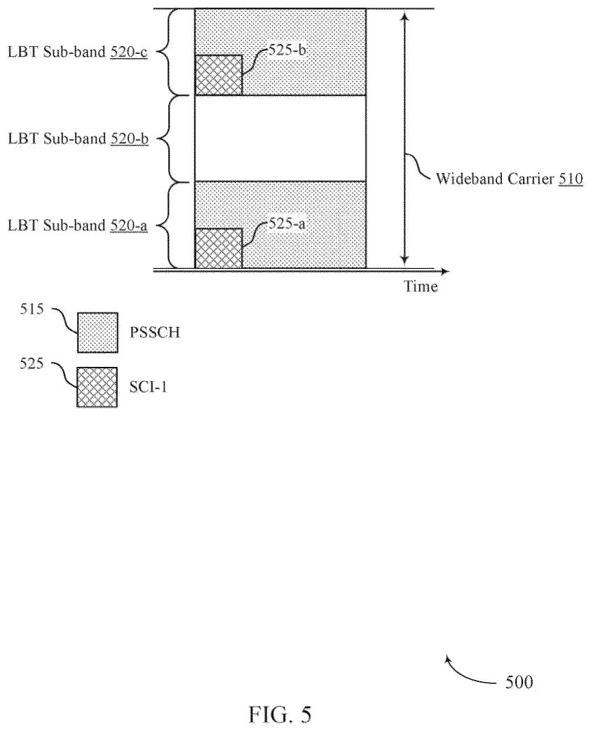

FIG. 5 illustrates an example of a wideband carrier diagram 500 that supports techniques for partial sidelink transmission using wideband operations in accordance with one or more aspects of the present disclosure. In some examples, the wideband carrier diagram 500 may implement aspects of the wireless communications system 100, the network architecture 200, the wireless communications system 300, and the wideband carrier diagram 400. For example, the wideband carrier diagram 500 may be implemented at a network entity or a UE, or both, which may be examples of the corresponding devices as described with reference to FIGS. 1 through 4.

In some examples, a wireless communications system may support wideband operations for sidelink communications using the unlicensed radio frequency spectrum band. For example, the network entity may configure one or more UEs (or the one or more UEs may be otherwise configured) for wideband operations, such that the UEs may support sidelink communications using a wideband carrier 510 that includes multiple LBT sub-bands (e.g., an LBT sub-band 520-a, an LBT sub-band 520-b, and an LBT sub-band 520-c). In some examples, a first UE (e.g., a transmitting UE) may indicate resources (e.g., frequency domain resources) to be used for transmission of a PSSCH message or portions of a PSSCH message irrespective of a frequency location of an associated PSCCH (e.g., a PSCCH message including an SCI). That is, a frequency resource allocation of a PSSCH 515 (e.g., to be used for transmitting PSSCH messages) may be decoupled from a PSCCH frequency location.

For example, as illustrated in the example of FIG. 5, the first UE may perform multiple LBT procedures to gain access to the channel for sidelink transmissions using one or more LBT sub-bands 520 of the wideband carrier 510. In some examples, the first UE may perform a first LBT procedure for (e.g., associated with) the LBT sub-band 520-a, a second LBT procedure for the LBT sub-band 520-b, and a third LBT procedure for LBT sub-band 520-c. In such examples, the second LBT procedure associated with the LBT sub-band 520-b may fail. Additionally, or alternatively, the first LBT procedure (e.g., associate with the LBT sub-band 520-a) and the second LBT procedure (e.g., associated with the LBT sub-band 520-c) may be successful. In such an example, the first UE may transmit SCI-1 525-a using the LBT sub-band 520-a and SCI-1 525-b using the LBT sub-band 520-c. The SCI-1 525-a may indicate one or more frequency resources of the LBT sub-band 520-a to be used for transmitting a portion of a PSSCH message (e.g., using the PSSCH 515 associated with the LBT sub-band 520-a) and the SCI-1 525-b may indicate one or more frequency resources of the LBT sub-band 520-c to be used for transmitting another portion of the PSSCH message (e.g., using the PSSCH 515 associated with the LBT sub-band 520-c). In the example of FIG. 5, the SCI-1 525-a and the SCI-1 525-b may correspond to first type of SCI (e.g., SCI format 1).

In some examples, the SCI-1 525-a and the SCI-1 525-b may indicate the one or more frequency resources (e.g., of the LBT sub-band 520-a and the LBT sub-band 520-c, respectively) using a quantity of bits that may be based on the wideband operations and a FRIV associated with the respective one or more frequency resources. For example, the first UE (e.g., a device configured for wideband operation) may reserve (e.g., be configured to reserve) a quantity of frequency resources (e.g., up to 2 frequency resource) that may be configured (e.g., indicate to a second UE) using a quantity of bits. In some examples, the first UE may use a higher layer parameter (e.g., a sl-MaxNumPerReserve IE) configured to 1 to reserve a resource (e.g., one resource) for transmission of one or more portions of a PSSCH message using the PSSCH 515. In such an example, the first UE may indicate the frequency resources using a quantity of bits (e.g., transmitted using the SCI-1 525-a or the SCI-1 525-b, or both) in accordance with the following Equation 1:

$$[ {log}_{2} ( \frac{{N}_{s u b C h a n n e l}^{S L} ( {N}_{s u b C h a n n e l}^{SL} + 1 )}{2} ) ] \qquad ( 1 )$$

in which

$${N}_{s u b C h a n n e l}^{S L}$$

may correspond to a quantity of sub-channels in a resource pool (e.g., provided according to another higher layer parameter, such as a numSubchannel IE). In some examples, such as examples in which the higher layer parameter is configured to 1, the SCI-1 525-a or the SCI-1 525-b (or both) may include a FRIV determined in accordance with the following Equation 2:

$$FRIV = {n}_{s u b C H , 0}^{start} + {\sum }_{i = 1}^{{L}_{s u b C H} - 1} ( {N}_{s u b C h a n n e l}^{S L} + 1 - i ) \qquad ( 2 )$$

in which

$${n}_{s u b C H , 0}^{start}$$

may may correspond to a beginning (e.g., starting) sub-channel index for the resource and L_{subCH} may correspond to a quantity of sub-channels (e.g., a quantity of contiguous sub-channels) within the resource pool. Additionally, or alternatively, the first UE may use the higher layer parameter (e.g., the sl-MaxNumPerReserve IE) configured to 2 to reserve two resource for transmission of one or more portions of a PSSCH message using the PSSCH 515. In such an example, the first UE may indicate the frequency resources using another quantity of bits (e.g., transmitted using the SCI-1 525-a or the SCI-1 525-b, or both) in accordance with the following Equation 3:

$$[ {log}_{2} ( \frac{{N {}_{subChannel}^{SL} ( {N}_{subChannel}^{SL} + 1 ) ( 2 N {}_{subChannel}^{SL} + 1 )}_{}}{6} ) ] . \qquad ( 3 )$$

In some examples, such as examples in which the higher layer parameter is configured to 2, the SCI-1 525-a or the SCI-1 525-b (or both) may include a FRIV determined in accordance with the following Equation 4:

$$FRIV = {n}_{subCH , 0}^{start} + {n}_{subCH , 1}^{start} \cdot ( {N}_{s u b C h a n n e l}^{S L} + 1 - {L}_{s u b C H} ) + {\sum }_{i = 1}^{{L}_{s u b C H} - 1} {( {N}_{s u b C h a n n e l}^{S L} + 1 - i )}^{2} \qquad ( 4 )$$

in which

$${n}_{subCH , 0}^{start}$$

may correspond to a beginning sub-channel index for a first resource of the two resources and

$${n}_{subCH , 1}^{start}$$

may correspond to a beginning sub-channel index for a second resource of the two resources.

In some examples, the first UE or second UE (or both) may receive an indication of whether a frequency resource allocation (e.g., whether frequency resource allocation information provided to the respective UE) is to be used in accordance with (e.g., applies to, is associated with) wideband operations. For example, the network entity may indicate, to the first UE or the second UE, or both, that a frequency resource allocation (e.g., for transmission of one or more portions of a PSSCH message) is for wideband operations using control signaling, such as RRC signaling (e.g., via an RRC configuration message). Additionally, or alternatively, the first UE may transmit another SCI message (e.g., a second type of SCI message, such as SCI format 2) that may include one or more bits (e.g., a bit field) that indicate, to the second UE, that a frequency resource allocation (e.g., for transmission of one or more portions of a PSSCH message) is for wideband operations. For example, the other SCI message may indicate whether a switch may occur between a default operation and a wideband operation for a subsequent (e.g., next) sidelink transmission (e.g., a transmission of one or more portions of a PSSCH message). That is, if the first UE is operating in a default operation mode (e.g., a non-wideband operation mode), the UE first UE may transmit, to the second UE, the other SCI that may include a bit field with a value 0. Additionally, or alternatively, the first UE may switch the value of the bitfield to 1 to indicate, to the second UE, a switch from the default operation mode to a wideband operation mode for a subsequent transmission. That is, the first UE may use a bitfield set to 0 (e.g., and included in the other SCI) to indicate that a frequency resource allocation may be for a default operation and a bitfield set to 1 to indicate that a frequency resource allocation may be for wideband operations. In some examples, indicating whether a frequency resource allocation is to be used in accordance with wideband operations may lead to increased resource utilization with a wireless communications system, among other possible benefits.

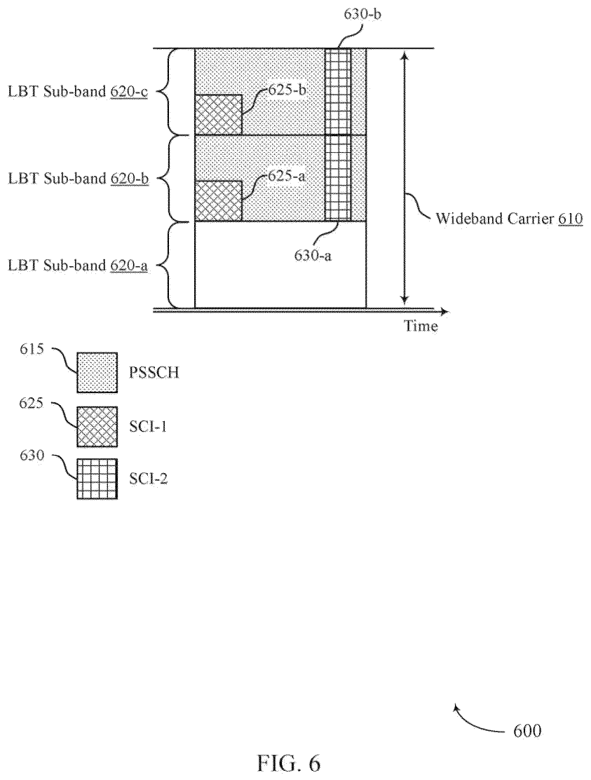

FIG. 6 illustrates an example of a wideband carrier diagram 600 that supports techniques for partial sidelink transmission using wideband operations in accordance with one or more aspects of the present disclosure. In some examples, the wideband carrier diagram 600 may implement aspects of the wireless communications system 100, the network architecture 200, the wireless communications system 300, the wideband carrier diagram 400, and the wideband carrier diagram 500. For example, the wideband carrier diagram 600 may be implemented at a network entity or a UE, or both, which may be examples of the corresponding devices as described with reference to FIGS. 1 through 5.

In some examples, the network entity may configure one or more UEs (or the one or more UEs may be otherwise configured) for wideband operations. In such examples, the UEs may support sidelink communications using a wideband carrier 610 that include multiple LBT sub-bands (e.g., an LBT sub-band 620-a, an LBT sub-band 620-b, and an LBT sub-band 620-c). In some examples, a first UE of the one or more UEs (e.g., a transmitting UE) may indicate, to a second UE of the one or more UEs (e.g., a receiving UE), frequency domain resources to be used for transmission of one or more portions of a PSSCH message irrespective of a frequency location of an associated PSCCH (e.g., including an SCI). That is, a frequency resource allocation of a PSSCH 615 (e.g., to be used for transmitting PSSCH messages) may be decoupled from a PSCCH frequency location.

For example, as illustrated in the example of FIG. 6, the first UE may perform multiple LBT procedures to gain access to the channel for sidelink transmissions using one or more LBT sub-bands of the wideband carrier 610. In some examples, the first UE may perform a first LBT procedure for the LBT sub-band 620-a, a second LBT procedure for the LBT sub-band 620-b, and a third LBT procedure for LBT sub-band 620-c. In such examples, the first LBT procedure associated with the LBT sub-band 620-a may fail. Additionally, or alternatively, the second LBT procedure (e.g., associate with the LBT sub-band 620-b) and the third LBT procedure (e.g., associated with the LBT sub-band 620-c) may be successful. In such an example, the first UE may transmit SCI-1 625-a using the LBT sub-band 620-b and SCI-1 625-b using the LBT sub-band 620-c. Additionally, or alternatively, the first UE may transmit SCI-2 630-a using the LBT sub-band 620-b and SCI-2 630-b using the LBT sub-band 620-c. In the example of FIG. 6, the SCI-1 625-a and the SCI-1 625-b may correspond to a first type of SCI (e.g., SCI format 1) and the SCI-2 630-a and the SCI-2 630-b may correspond to a second type of SCI (e.g., SCI format 2). In some examples, the SCI-1 625-a and the SCI-1 625-b may indicate a quantity of subchannels (e.g., a quantity of contiguous sub-channels) within a resource pool (e.g., may indicate the parameter L_{subCH}), while the SCI-2 630-a and the SCI-2 630-b may indicate a beginning subchannel index of a first resource (e.g., of one or more resources reserved for transmission of a PSSCH message using the PSSCH 615) associated with the respective LBT sub-band (e.g., may indicate the parameter

$${n}_{subCH , 0}^{start}$$

for the respective LBT sub-band).

In some examples, the network may configure the first UE and the second UE (or the first UE and the second UE may be otherwise configured or preconfigured, such as with one or more rules) with one or more mapping rules associated with the SCI-2 630-a and the SCI-2 630-b. In some examples, a mapping rule (e.g., of the one or more mapping rules configured at the first UE and the second UE) may indicate that a mapping (e.g., an indication of a beginning subchannel index of a first resource of one or more resources reserved for transmission of the PSSCH message using the PSSCH 615) indicated using an SCI format 2 (e.g., the SCI-2 630-a, the SCI-2 630-b) may correspond to one LBT sub-band (e.g., the LBT sub-band 620-b or the LBT sub-band 620-c). Additionally, or alternatively, the mapping rule (or another mapping rule) may indicate that the mapping provided using the SCI format 2 may be repeated for multiple (e.g., each) LBT sub-band (e.g., the LBT sub-band 620-b and the LBT sub-band 620-c). For example, a mapping associated with (e.g., provided using, indicated using) the SCI-2 630-a may correspond to the LBT sub-band 620-b and a mapping associated with the SCI-2 630-b may correspond to the LBT sub-band 620-c.

In some examples, the mapping between the SCI-2s 630 and the respective LBT sub-bands 620 may be provided (e.g., indicated, determined) using a bit field. For example, the SCI-2s 630 may include a bit field that indicates, for the respective LBT sub-band 620 (e.g., the LBT sub-band in which the respective SCI-2 630 may be transmitted), the beginning subchannel index of the first resource of one or more resources reserved for transmission of the PSSCH message using the PSSCH 615 (e.g., associated with the LBT sub-band in which the respective SCI-2 630 may be transmitted). In some examples, the beginning subchannel index of the first resource may be determined in accordance with the following Equation 5:

$${n}_{subCH , 0}^{start} = {n}_{subCH , {SCI}^{′}}^{start} - {B}_{L B T} \qquad ( 5 )$$

in which

$${n}_{subCH , {SCI}^{′}}^{start}$$

may correspond to the beginning subchannel index of the first resource of an LBT sub-band in which the respective SCI-2 630 may have been transmitted and B_{LBT} may correspond to an index associated with the LBT sub-band. The index associated with the LBT sub-band may be based on a respective order (e.g., or frequency position) of the LBT sub-band relative to one or more other LBT sub-bands. For example, the LBT sub-band 620-a may include a relatively lowest frequency of multiple frequencies included in the wideband carrier 610. Accordingly, an index associated with the LBT sub-band 620-a may correspond to a relatively lowest value among multiple indices associated with the LBT sub-bands 620 included in the wideband carrier 610. As an illustrative example, the index associated with the LBT sub-band 620-a may correspond to value of 0 (e.g., B_{LBT} may be configured with a value of 0 for the LBT sub-band 620-a), the index associated with the LBT sub-band 620-b may correspond to a value of 1 (e.g., B_{LBT} may be configured with a value of 1 for the LBT sub-band 620-b), and the index associated with the LBT sub-band 620-c may correspond to a value of 2 (e.g., B_{LBT} may be configured with a value of 2 for the LBT sub-band 620-c).

Additionally, or alternatively, the mapping between the SCI-2s 630 and the respective LBT sub-band 620 may be indicated using a bit field. For example, the SCI-2s 630 (e.g., the SCI-2 630-a, the SCI-2 630-b) may include a bitmap that indicates a status of an LBT procedure associated with the LBT sub-band in which the respective SCI-2 630 may have be transmitted. In some examples, the status of the LBT procedure may indicate whether the LBT procedure of the respective LBT sub-band failed. For example, the SCI-2 630-a may include a bitmap that indicates the status of an LBT procedure associated with the LBT sub-band 620-b and the SCI-2 630-b may include a bitmap that indicates the status of an LBT procedure associated with the LBT sub-band 620-c. In some examples, the first UE (e.g., and the second UE) may be configured with another mapping rule that may indicate that a bitmap value of 1 corresponds to an LBT procedure success and a bitmap value of 0 corresponds to an LBT procedure failure. In such an example, the one or more frequency resources may be determined (e.g., at the second UE) based on the bitmap value. In some examples, configuring the first UE and the second UE with one or more rules associated with the SCI-2 630-a and the SCI-2 630-b may provide one or more enhancements for partial sidelink transmissions using a wideband carrier (e.g., the wideband carrier 610).

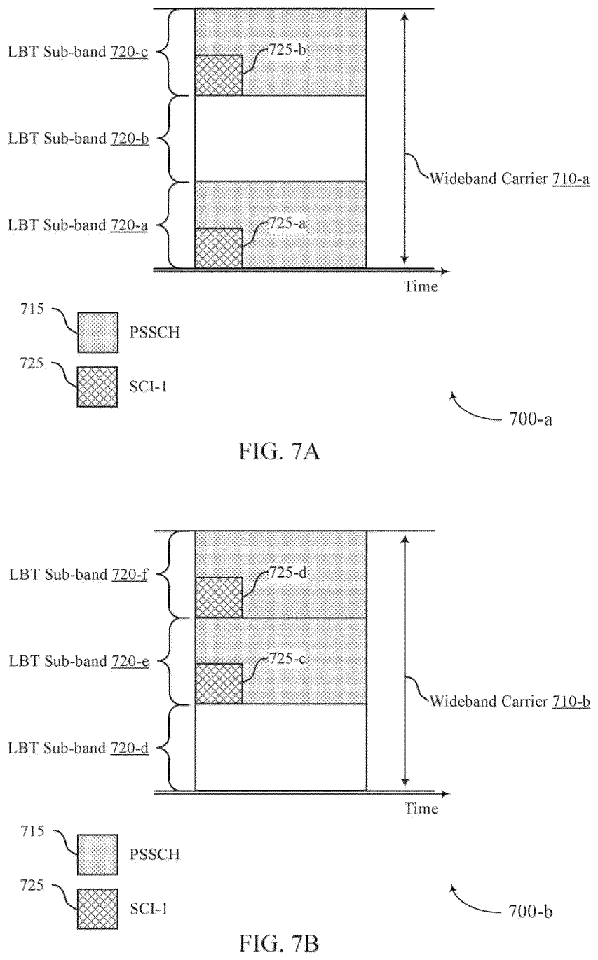

FIGS. 7A and 7B illustrate examples of a wideband carrier diagrams 700 (e.g., a wideband carrier diagram 700-a and a wideband carrier diagram 700-b) that supports techniques for partial sidelink transmission using wideband operations in accordance with one or more aspects of the present disclosure. In some examples, the wideband carrier diagrams 700 may implement aspects of the wireless communications system 100, the network architecture 200, the wireless communications system 300, the wideband carrier diagram 400, the wideband carrier diagram 500, and the wideband carrier diagram 600. For example, the wideband carrier diagrams 700 may be implemented at a network entity or a UE, or both, which may be examples of the corresponding devices as described with reference to FIGS. 1 through 6.

In some examples, the network entity may configure one or more UEs (or the one or more UEs may be otherwise configured or preconfigured, such as with one or more rules) for wideband operations, such that the one or more UEs may support sidelink communications using wideband carriers 710 (e.g., a wideband carrier 710-a and a wideband carrier 710-b) that may each include multiple LBT sub-bands. For example, the wideband carrier 710-a may include an LBT sub-band 720-a, an LBT sub-band 720-b, and an LBT sub-band 720-c. Additionally, or alternatively, the wideband carrier 710-b may include an LBT sub-band 720-d, an LBT sub-band 720-e, and an LBT sub-band 720-f. In some examples, a first UE (e.g., a transmitting UE) may indicate to a second UE (e.g., a receiving UE) one or more frequency resources to be used for transmission of a PSSCH message or portions of a PSSCH message (e.g., at the first UE) irrespective of a frequency location of an associated PSCCH (e.g., including an SCI). That is, a frequency resource allocation of a PSSCH 715 (e.g., to be used for transmitting PSSCH messages) may be decoupled from a PSCCH frequency location. In some examples, the first UE may indicate one or more frequency resources of an LBT sub-band to be used for transmission of the PSSCH message (or one or more portions of the PSSCH message) using a CRC mask or a scrambling indication, or both. In some examples, the scrambling indication may indicate a scrambling identifier (e.g., a radio network temporary identifier (RNTI) or another scrambling identifier associated with the RNTI) or an index associated with the LBT sub-band (e.g., B_{LBT}), or both.

For example, the first UE may scramble a quantity of bits included in an SCI (e.g., an SCI-1 725-a, an SCI-1 725-b, an SCI-1 725-c, an SCI-1 725-d) that may indicate one or more frequency resources of the LBT sub-band in which the SCI may be transmitted. In some examples, the first UE may scramble the quantity of bits using an RNTI (or using some other suitable scrambling mechanism). In such examples, the second UE may determine the one or more resources based on a mapping between multiple LBT sub-bands and the scrambled bits (e.g., a CRC bit mask) or the scrambling indication, or both. The network may configure the first UE and the second UE with the mapping or the mapping may be otherwise configured at the first UE and the second UE. For example, the network may transmit, to the first UE and the second UE, control signaling (e.g., RRC signaling) that may indicate (e.g., configure the UEs with) one or more CRC masks or scrambling identifiers (e.g., RNTIs), or both, to apply to the multiple LBT sub-bands (e.g., sequentially or in some other suitable order). In such an example, the second UE (e.g., the sidelink receiver) may determine the one or more resources (e.g., the PSSCH frequency allocation) based on the detected CRC mask or the scrambling indication, or both.

For example, as illustrated in the example of FIG. 7A, the first UE may perform multiple LBT procedures to gain access to the channel for sidelink transmissions using one or more LBT sub-bands of the wideband carrier 710-a. In some examples, the first UE may perform a first LBT procedure for (e.g., associated with) the LBT sub-band 720-a, a second LBT procedure for the LBT sub-band 720-b, and a third LBT procedure for LBT sub-band 720-c. In such examples, the second LBT procedure associated with the LBT sub-band 720-b may fail. Additionally, or alternatively, the first LBT procedure (e.g., associate with the LBT sub-band 720-a) and the second LBT procedure (e.g., associated with the LBT sub-band 720-c) may be successful. In such an example, the first UE may transmit SCI-1 725-a using the LBT sub-band 720-a and a SCI-1 725-b using the LBT sub-band 720-c.

In the example of FIG. 7A, the SCI-1 725-a and the SCI-1 725-b may correspond to a first type of SCI (e.g., SCI format 1). The SCI-1 725-a may indicate one or more frequency resources of the LBT sub-band 720-a to be used for transmitting a portion of a PSSCH message (e.g., using the PSSCH 715 of the LBT sub-band 720-a). For example, the SCI-1 725-a may include a scrambling indication (or CRC mask) that may indicate a beginning subchannel index (e.g., starting point) associated with the SCI-1 725-a (e.g., a beginning subchannel index of the first resource of one or more resources reserved for transmission of the PSSCH message using the PSSCH 715). In some examples, the SCI-1 725-a may indicate the beginning subchannel index using a scrambling indication that identifies a scrambling ID and an index associated with the LBT sub-band 720-a (e.g., a parameter B_{LBT} that may be configured with a value of 0). That is, a value of the parameter n_{subCH,0}^{start} for LBT sub-band 720-a may correspond to a beginning subchannel index of the SCI-1 725-a. Additionally, or alternatively, The SCI-1 725-b may indicate one or more frequency resources of the LBT sub-band 720-c to be used for a portion of a PSSCH message (e.g., transmitted using the PSSCH 725 of the LBT sub-band 720-c). For example, the SCI-1 725-b may include a scrambling indication (or CRC mask) that may indicate a beginning sub-carrier index (e.g., starting point) associated with the SCI-1 725-b (e.g., beginning subchannel index of the first resource of one or more resources reserved for transmission of the PSSCH message using the PSSCH 715). In some examples, the SCI-1 725-b may indicate the beginning sub-carrier index using a scrambling indication that identifies a scrambling ID and an index associated with the LBT sub-band 720-c (e.g., a parameter B_{LBT} that may be configured with a value of 2).

Additionally, or alternatively, as illustrated in the example of FIG. 7B, the first UE may perform multiple LBT procedures to gain access to the channel for sidelink transmissions using one or more LBT sub-bands of the wideband carrier 710-b. In some examples, the first UE may perform a first LBT procedure for (e.g., associated with) the LBT sub-band 720-d, a second LBT procedure for the LBT sub-band 720-e, and a third LBT procedure for LBT sub-band 720-f. In such examples, the UE first LBT procedure associated with the LBT sub-band 720-d may fail. Additionally, or alternatively, the second LBT procedure (e.g., associate with the LBT sub-band 720-e) and the third LBT procedure (e.g., associated with the LBT sub-band 720-f) may be successful. In such an example, the first UE may transmit SCI-1 725-c using the LBT sub-band 720-e and SCI-1 725-d using the LBT sub-band 720-f.

In the example of FIG. 7B, the SCI-1 725-c and the SCI-1 725-d may correspond to a first type of SCI (e.g., SCI format 1). The SCI-1 725-c may indicate one or more frequency resources of the LBT sub-band 720-e to be used for transmitting a portion of a PSSCH message (e.g., using the PSSCH 725 of the LBT sub-band 720-e). For example, the SCI-1 725-c may include a scrambling indication (or CRC mask) that may indicate a beginning sub-carrier index (e.g., starting point) associated with the SCI-1 725-c (e.g., beginning subchannel index of the first resource of one or more resources reserved for transmission of the PSSCH message using the PSSCH 715). In some examples, the SCI-1 725-c may indicate the beginning sub-carrier index using a scrambling indication that identifies a scrambling ID and an index associated with the LBT sub-band 720-e (e.g., a parameter B_{LBT} that may be configured with a value of 1). That is, a value of the parameter

$${n}_{subCH , 0}^{start}$$

for LBT sub-band 720-e may correspond to a difference between a beginning sub-carrier index (e.g., a starting point) of the SCI-1 725-c and the parameter B_{LBT} that may be configured with a value of 1.

Additionally, or alternatively, the SCI-1 725-d may indicate one or more frequency resources of the LBT sub-band 720-f to be used for a portion of a PSSCH message (e.g., transmitted using the PSSCH 725 of the LBT sub-band 720-f). For example, the SCI-1 725-d may include a scrambling indication (or CRC mask) that may indicate a beginning sub-carrier index (e.g., starting point) associated with the SCI-1 725-d (e.g., beginning subchannel index of the first resource of one or more resources reserved for transmission of the PSSCH message using the PSSCH 715). In some examples, the SCI-1 725-d may indicate the beginning sub-carrier index using a scrambling indication that identifies a scrambling ID and an index associated with the LBT sub-band 720-f (e.g., a parameter B_{LBT} that may be configured with a value of 2). In some examples, configuring the first UE and the second UE with one or more mapping rules may provide increased resource utilization within the wireless communications system, among other possible benefits.

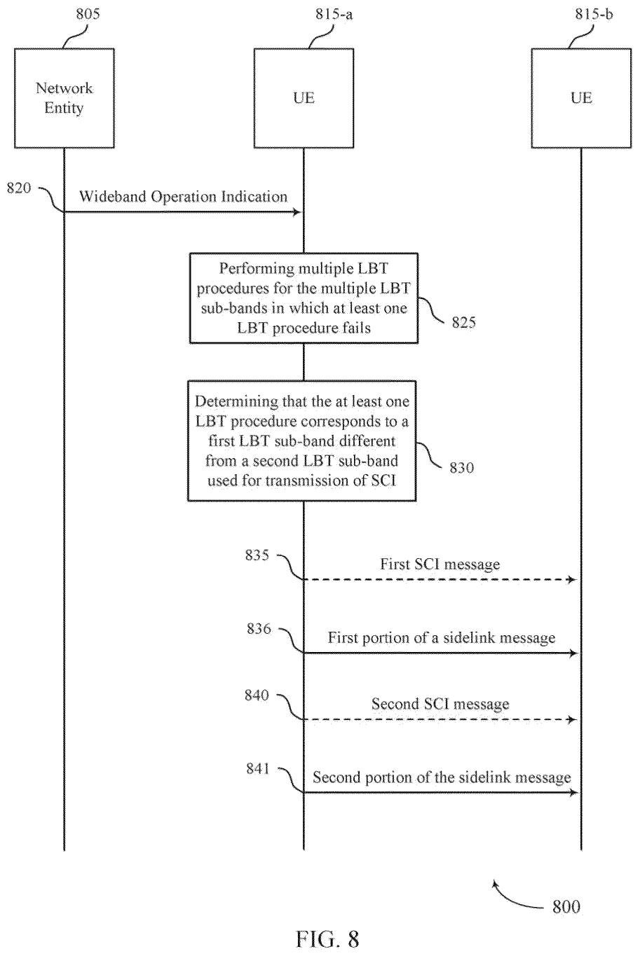

FIG. 8 illustrates an example of a process flow 800 that supports techniques for partial sidelink transmission using wideband operations in accordance with one or more aspects of the present disclosure. The process flow 800 may implement or be implemented at or using one or more aspects of the wireless communications system 100, the network architecture 200, the wireless communications system 300, the wideband carrier diagram 400, the wideband carrier diagram 500, the wideband carrier diagram 600 and the wideband carrier diagrams 700. For example, the process flow 800 may be implemented by a network entity 805, a UE 815-a, or a UE 815-b, which may be examples of the corresponding devices described with reference to FIGS. 1-6, 7A, and 7B. In some examples, the network entity 805 and the UEs 815 may implement the process flow 800 to promote network efficiencies by supporting a framework for partial sidelink transmissions using a wideband carrier. The process flow 800 may also be implemented by the network entity 805 and the UEs 815 to promote high reliability and low latency operations, among other benefits. In the following description of the process flow 800, the operations between the UEs 815 and the network entity 805 may occur in a different order than the example order shown, or the operations performed by the UEs 815 and the network entity 805 may be performed in different orders or at different times. Some operations may also be omitted.

At 820, the UE 815-a may receive (e.g., from the network entity 805) a control message including a wideband operation indication that indicates, to the UE 815-a, to perform wideband operations for partial sidelink messages using a carrier of an unlicensed radio frequency spectrum band. The carrier may be an example of a wideband carrier as described throughout the present disclosure, including with reference to FIGS. 3 through 6, 7A, and 7B. For example, the carrier may include multiple LBT sub-bands. Additionally, or alternatively, the wideband operations may be examples of wideband operations as described throughout the present disclosure, including with reference to FIGS. 1 through 6, 7A, and 7B. For example, the wideband operations may be associated with communications using a bandwidth that exceeds a threshold bandwidth (e.g., using the wideband carrier).

At 825, the UE 815-a may perform multiple LBT procedures for the multiple LBT sub-bands in which at least one LBT procedure may fails. That is, the UE 815-a may perform multiple LBT procedures in which each LBT procedure (e.g., of the multiple LBT procedures) may correspond to a respective LBT sub-band.

At 830, the UE 815-a may determine that the at least one LBT procedure (e.g., that failed) corresponds to a first LBT sub-band that is different from a second LBT sub-band used for transmission of SCI. For example, the second LBT sub-band may correspond to an LBT sub-band that may be used (e.g., at the UE 815-a) for transmission of the SCI using a PSCCH and one or more other sidelink messages using a PSSCH (e.g., sidelink data messages, PSSCH messages).

In some examples, the UE 815-a may transmit one or more portions of a sidelink message (e.g., one or more portions of a PSSCH message, one or more partial sidelink messages) using one or more LBT sub-bands (e.g., of the multiple LBT sub-bands). For example, the UE 815-a may transmit the one or more portions of the sidelink message using one or more frequency resources of the one or more LBT sub-bands that may be based on the wideband operations. In some examples, the UE 815-a may indicated the one or more frequency resources to the UE 815-b using SCI.

For example, at 835, the UE 815-a may transmit a first SCI message using the first LBT sub-band (e.g., based on an LBT procedure corresponding to the first LBT sub-band being successful) that indicates one or more frequency resources of the first LBT sub-band for a first portion of the sidelink message. At 836 the UE 815-a may transmit, to the UE 815-b, the first portion of the sidelink message using the one or more frequency resources of the first LBT sub-band.

In some examples, at 840, the UE 815-a may transmit a second SCI message using a third LBT sub-band (e.g., different from the first LBT sub-band and the second LBT sub-band) based on an LBT procedure corresponding to the third LBT sub-band being successful. The second SCI message may indicate one or more frequency resources of the third LBT sub-band for a second portion of the sidelink message. At 841 the UE 815-a may transmit, to the UE 815-b, the second portion of the sidelink message using the one or more frequency resources of the third LBT sub-band.

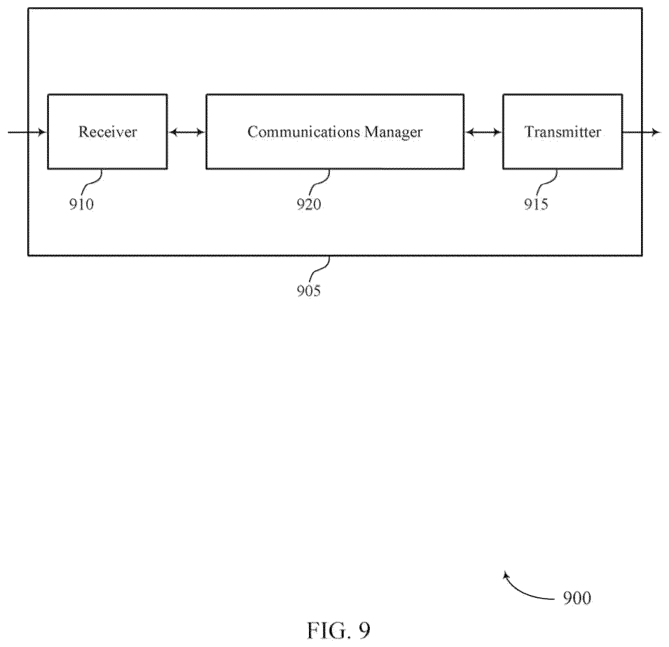

FIG. 9 shows a block diagram 900 of a device 905 that supports techniques for partial sidelink transmission using wideband operations in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for partial sidelink transmission using wideband operations). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for partial sidelink transmission using wideband operations). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for partial sidelink transmission using wideband operations as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE (e.g., the device 905) in accordance with examples as disclosed herein. For example, the communications manager 920 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The communications manager 920 may be configured as or otherwise support a means for performing a set of multiple LBT procedures for the set of multiple LBT sub-bands, where at least one LBT procedure of the set of multiple LBT procedures fails. The communications manager 920 may be configured as or otherwise support a means for transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI.

Additionally, or alternatively, the communications manager 920 may support wireless communication at a UE (e.g., the device 905) in accordance with examples as disclosed herein. For example, the communications manager 920 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The communications manager 920 may be configured as or otherwise support a means for performing a set of multiple LBT procedures for the set of multiple LBT sub-bands, where at least one LBT procedure of the set of multiple LBT procedures fails. The communications manager 920 may be configured as or otherwise support a means for transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations. The communications manager 920 may be configured as or otherwise support a means for transmitting the portion of the sidelink message using the one or more frequency resources.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

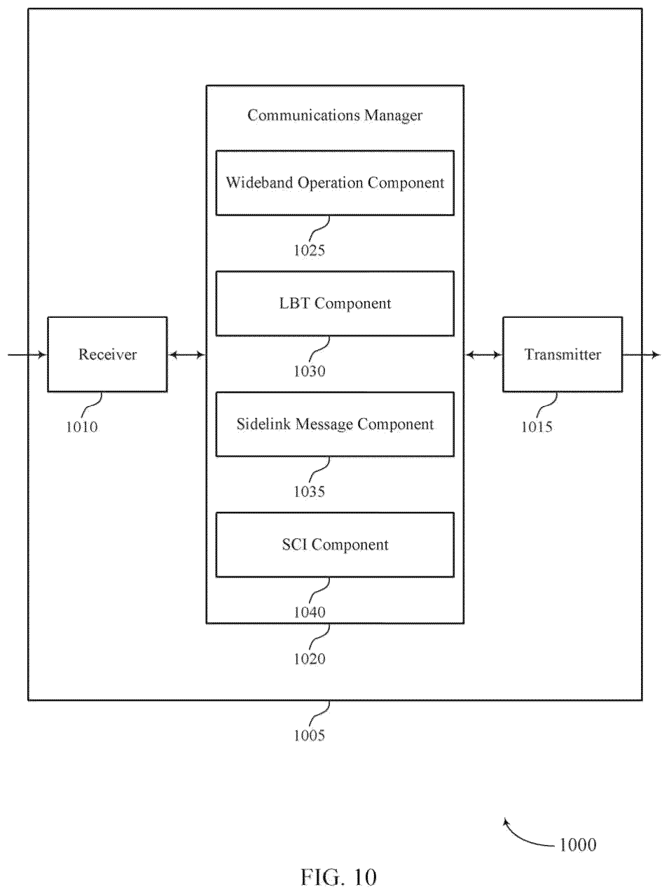

FIG. 10 shows a block diagram 1000 of a device 1005 that supports techniques for partial sidelink transmission using wideband operations in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for partial sidelink transmission using wideband operations). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for partial sidelink transmission using wideband operations). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for partial sidelink transmission using wideband operations as described herein. For example, the communications manager 1020 may include a wideband operation component 1025, an LBT component 1030, a sidelink message component 1035, an SCI component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE (e.g., the device 1005) in accordance with examples as disclosed herein. The wideband operation component 1025 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The LBT component 1030 may be configured as or otherwise support a means for performing a set of multiple LBT procedures for the set of multiple LBT sub-bands, where at least one LBT procedure of the set of multiple LBT procedures fails. The sidelink message component 1035 may be configured as or otherwise support a means for transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI.

Additionally, or alternatively, the communications manager 1020 may support wireless communication at a UE (e.g., the device 1005) in accordance with examples as disclosed herein. The wideband operation component 1025 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The LBT component 1030 may be configured as or otherwise support a means for performing a set of multiple LBT procedures for the set of multiple LBT sub-bands, where at least one LBT procedure of the set of multiple LBT procedures fails. The SCI component 1040 may be configured as or otherwise support a means for transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations. The sidelink message component 1035 may be configured as or otherwise support a means for transmitting the portion of the sidelink message using the one or more frequency resources.

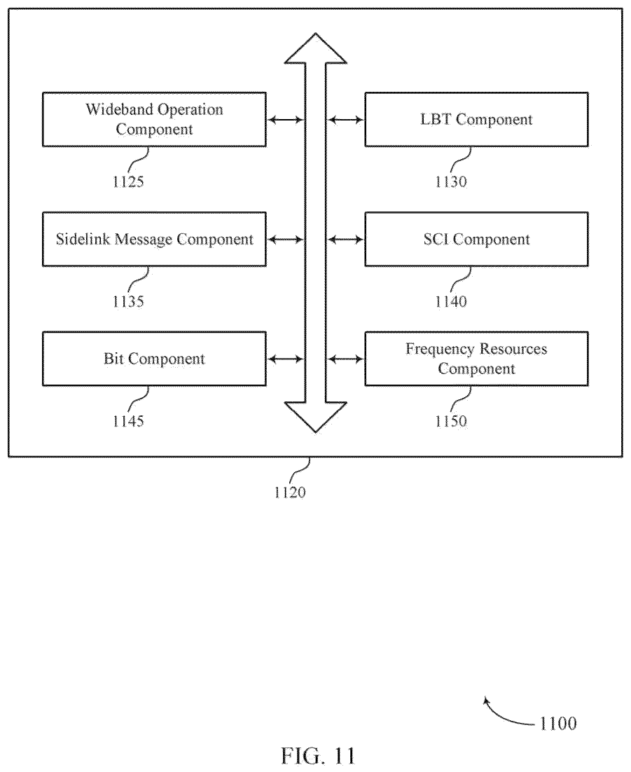

FIG. 11 shows a block diagram 1100 of a communications manager 1120 that supports techniques for partial sidelink transmission using wideband operations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for partial sidelink transmission using wideband operations as described herein. For example, the communications manager 1120 may include a wideband operation component 1125, an LBT component 1130, a sidelink message component 1135, an SCI component 1140, a bit component 1145, a frequency resources component 1150, or any combination thereof. Each of these components may communicate, directly or indirectly, with one another (e.g., via one or more buses).

The communications manager 1120 may support wireless communication at a UE in accordance with examples as disclosed herein. The wideband operation component 1125 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The LBT component 1130 may be configured as or otherwise support a means for performing a set of multiple LBT procedures for the set of multiple LBT sub-bands, where at least one LBT procedure of the set of multiple LBT procedures fails. The sidelink message component 1135 may be configured as or otherwise support a means for transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI.

In some examples, the LBT component 1130 may be configured as or otherwise support a means for performing a second set of multiple LBT procedures for the set of multiple LBT sub-bands, where an LBT procedure of the second set of multiple LBT procedures fails. In some examples, the sidelink message component 1135 may be configured as or otherwise support a means for refraining from transmitting a second sidelink message based on the LBT procedure corresponding to the second LBT sub-band used for transmission of the SCI.

In some examples, the SCI component 1140 may be configured as or otherwise support a means for transmitting the SCI using a one or more sidelink control channel resources of the second LBT sub-band, where the SCI indicates or more respective sidelink shared channel resources of the one or more LBT sub-bands for the one or more portions of the sidelink message.

In some examples, the second LBT sub-band corresponds to a lowest set of frequencies of a set of multiple sets of frequencies associated with the set of multiple LBT sub-bands. In some examples, a sidelink control channel resource of the one or more sidelink control channel resources correspond to a lowest frequency of the second LBT sub-band.

In some examples, to support transmitting the one or more portions of the sidelink message, the sidelink message component 1135 may be configured as or otherwise support a means for transmitting respective portions of the sidelink message using respective LBT sub-bands of the one or more LBT sub-bands, where the respective LBT sub-bands correspond to successful LBT procedures.

Additionally, or alternatively, the communications manager 1120 may support wireless communication at a UE in accordance with examples as disclosed herein. In some examples, the wideband operation component 1125 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. In some examples, the LBT component 1130 may be configured as or otherwise support a means for performing a set of multiple LBT procedures for the set of multiple LBT sub-bands, where at least one LBT procedure of the set of multiple LBT procedures fails. The SCI component 1140 may be configured as or otherwise support a means for transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations. In some examples, the sidelink message component 1135 may be configured as or otherwise support a means for transmitting the portion of the sidelink message using the one or more frequency resources.

In some examples, the SCI component 1140 may be configured as or otherwise support a means for receiving a second control message that indicates, to the UE, one or more rules for indicating the one or more frequency resources of the LBT sub-band using the SCI, where the SCI is transmitted based on the second control message.

In some examples, to support transmitting the SCI, the bit component 1145 may be configured as or otherwise support a means for transmitting a quantity of bits that indicates the one or more frequency resources, where the quantity of bits is based on the wideband operations and a frequency resource indicator value associated with the one or more frequency resources.

In some examples, to support transmitting the SCI, the frequency resources component 1150 may be configured as or otherwise support a means for transmitting a first SCI message including an indication of a quantity of contiguous frequency resources including the one or more frequency resources. In some examples, to support transmitting the SCI, the frequency resources component 1150 may be configured as or otherwise support a means for transmitting a second SCI message including an indication of a frequency location of a frequency resource of the quantity of contiguous frequency resources, where the frequency location is relative to a lowest frequency of a set of frequencies associated with the LBT sub-band.

In some examples, the frequency location of the frequency resource is indicated using one or more bits that correspond to an index associated with the frequency resource. In some examples, the frequency location of the frequency resource is indicated using one or more bits that correspond to a status of the LBT procedure corresponding to the LBT sub-band.

In some examples, to support transmitting the SCI, the bit component 1145 may be configured as or otherwise support a means for scrambling a portion of bits included in the SCI, where the one or more frequency resources are indicated based on the scrambled portion of bits. In some examples, the scrambled portion of bits include CRC bits. In some examples, the portion of bits are scrambled using an RNTI. In some examples, the one or more frequency resources are indicated based on the RNTI and an index associated with the LBT sub-band.

In some examples, the SCI component 1140 may be configured as or otherwise support a means for transmitting second SCI using the LBT sub-band, the second SCI indicating that the portion of the sidelink message is to be transmitted using the wideband operations.

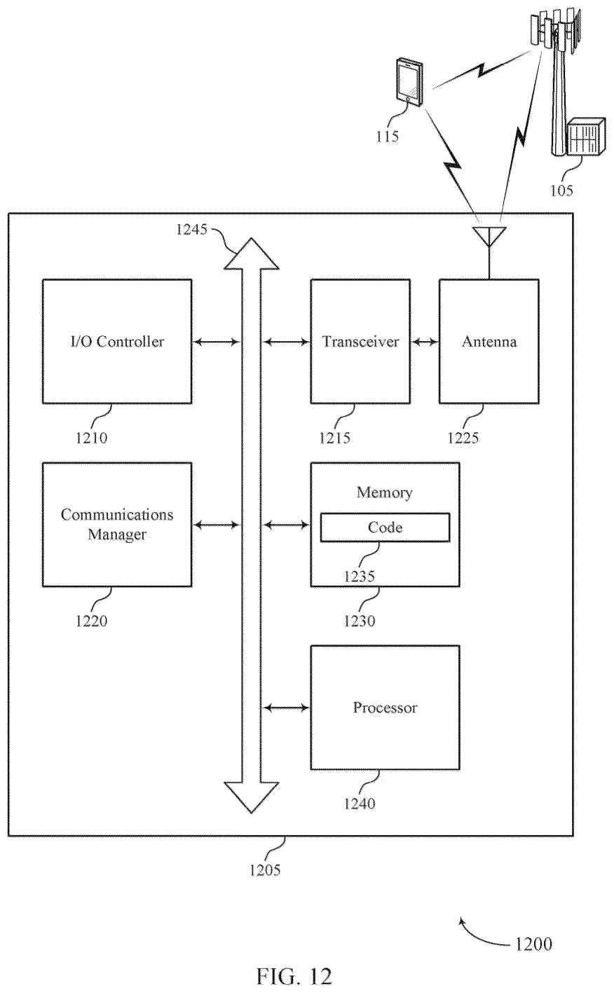

FIG. 12 shows a diagram of a system 1200 including a device 1205 that supports techniques for partial sidelink transmission using wideband operations in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for partial sidelink transmission using wideband operations). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE (e.g., the device 1205) in accordance with examples as disclosed herein. For example, the communications manager 1220 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The communications manager 1220 may be configured as or otherwise support a means for performing a set of multiple LBT procedures for the set of multiple LBT sub-bands, where at least one LBT procedure of the set of multiple LBT procedures fails. The communications manager 1220 may be configured as or otherwise support a means for transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI.

Additionally, or alternatively, the communications manager 1220 may support wireless communication at a UE (e.g., the device 1205) in accordance with examples as disclosed herein. For example, the communications manager 1220 may be configured as or otherwise support a means for receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The communications manager 1220 may be configured as or otherwise support a means for performing a set of multiple LBT procedures for the set of multiple LBT sub-bands, where at least one LBT procedure of the set of multiple LBT procedures fails. The communications manager 1220 may be configured as or otherwise support a means for transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations. The communications manager 1220 may be configured as or otherwise support a means for transmitting the portion of the sidelink message using the one or more frequency resources.

By including or configuring the communications manager 1220 in accordance with examples as described herein, the device 1205 may support techniques for improved communication reliability, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for partial sidelink transmission using wideband operations as described herein, or the processor 1240 and the memory 1230 may be otherwise configured to perform or support such operations.

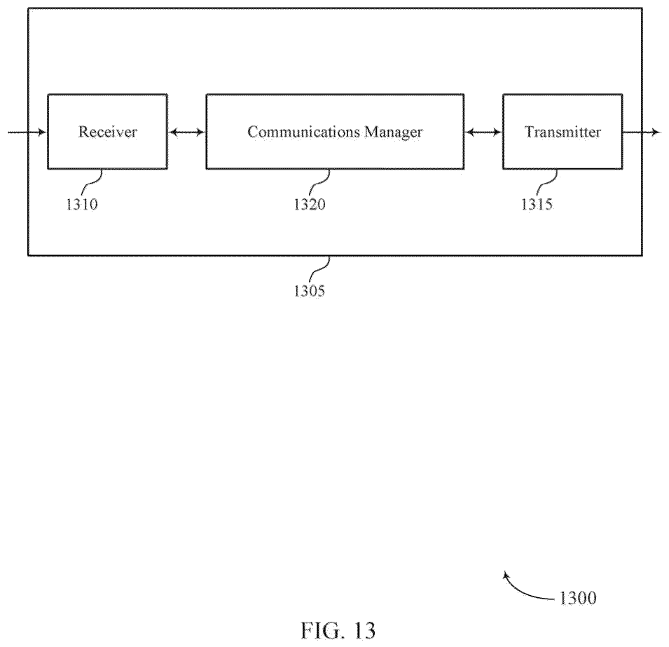

FIG. 13 shows a block diagram 1300 of a device 1305 that supports techniques for partial sidelink transmission using wideband operations in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of techniques for partial sidelink transmission using wideband operations as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity (e.g., the device 1305) in accordance with examples as disclosed herein. For example, the communications manager 1320 may be configured as or otherwise support a means for transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The communications manager 1320 may be configured as or otherwise support a means for transmitting a second control message that indicates, to the UE, one or more rules for identifying frequency resources of the set of multiple LBT sub-bands in which the partial sidelink messages are to be transmitted.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for more efficient utilization of communication resources.

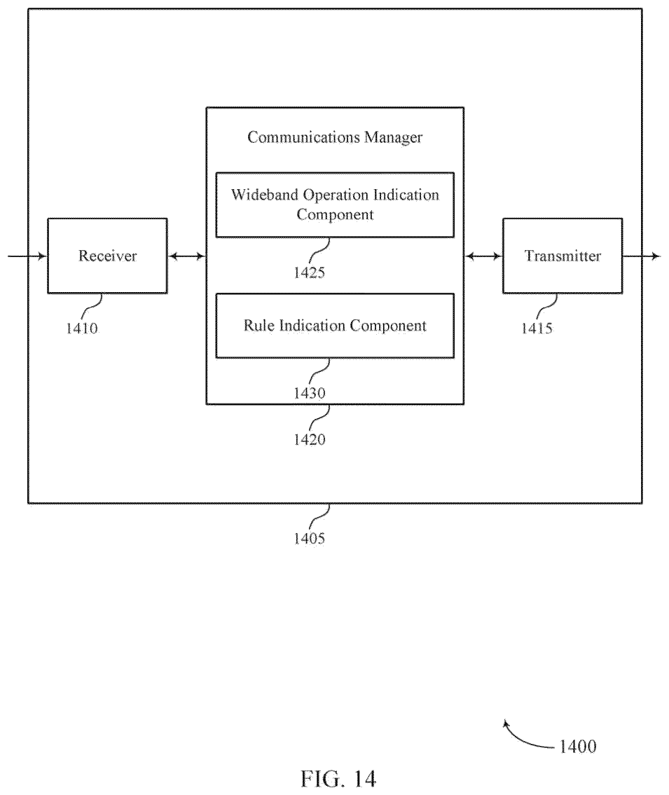

FIG. 14 shows a block diagram 1400 of a device 1405 that supports techniques for partial sidelink transmission using wideband operations in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of techniques for partial sidelink transmission using wideband operations as described herein. For example, the communications manager 1420 may include a wideband operation indication component 1425 a rule indication component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity (e.g., the device 1405) in accordance with examples as disclosed herein. The wideband operation indication component 1425 may be configured as or otherwise support a means for transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The rule indication component 1430 may be configured as or otherwise support a means for transmitting a second control message that indicates, to the UE, one or more rules for identifying frequency resources of the set of multiple LBT sub-bands in which the partial sidelink messages are to be transmitted.

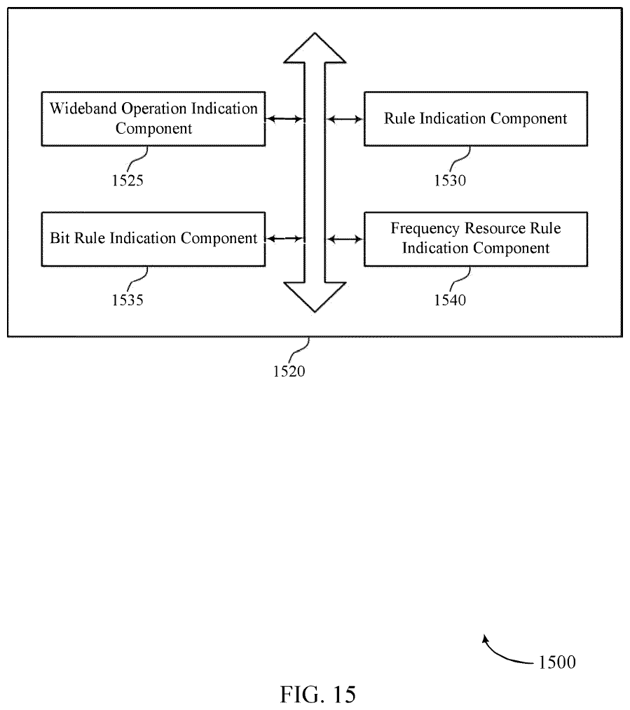

FIG. 15 shows a block diagram 1500 of a communications manager 1520 that supports techniques for partial sidelink transmission using wideband operations in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of techniques for partial sidelink transmission using wideband operations as described herein. For example, the communications manager 1520 may include a wideband operation indication component 1525, a rule indication component 1530, a bit rule indication component 1535, a frequency resource rule indication component 1540, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The wideband operation indication component 1525 may be configured as or otherwise support a means for transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The rule indication component 1530 may be configured as or otherwise support a means for transmitting a second control message that indicates, to the UE, one or more rules for identifying frequency resources of the set of multiple LBT sub-bands in which the partial sidelink messages are to be transmitted.

In some examples, to support transmitting the second control message, the bit rule indication component 1535 may be configured as or otherwise support a means for transmitting an indication of a rule of the one or more rules that indicates, to the UE, to identify the frequency resources using a quantity of bits transmitted using SCI, where the quantity of bits is based on the wideband operations and a frequency resource indicator value associated with the frequency resources.

In some examples, to support transmitting the second control message, the frequency resource rule indication component 1540 may be configured as or otherwise support a means for transmitting an indication of a rule of the one or more rules that indicates, to the UE, to identify the frequency resources using a first SCI message that includes an indication of a quantity of contiguous frequency resources including the frequency resources and a second SCI message including an indication of a frequency location of a frequency resource of the quantity of contiguous frequency resources, where the frequency location is relative to a lowest frequency of a set of frequencies associated with an LBT sub-band of the set of multiple LBT sub-bands.

In some examples, the rule further indicates that the frequency location of the frequency resource is to be identified using one or more bits that correspond to an index associated with the frequency resource. In some examples, the rule further indicates that the frequency location of the frequency resource is identified using one or more bits that correspond to a status of an LBT procedure corresponding to the LBT sub-band.

In some examples, to support transmitting the second control message, the bit rule indication component 1535 may be configured as or otherwise support a means for transmitting an indication of a rule of the one or more rules that indicates, to the UE, to identify the frequency resources using a portion of bits that are scrambled and included in a SCI message.

In some examples, the rule further indicates that the portion of bits include CRC bits. In some examples, the rule further indicates that the portion of bits are to be scrambled using an RNTI. In some examples, the frequency resources are to be indicated based on the RNTI and an index associated with a respective LBT sub-band of the set of multiple LBT sub-bands.

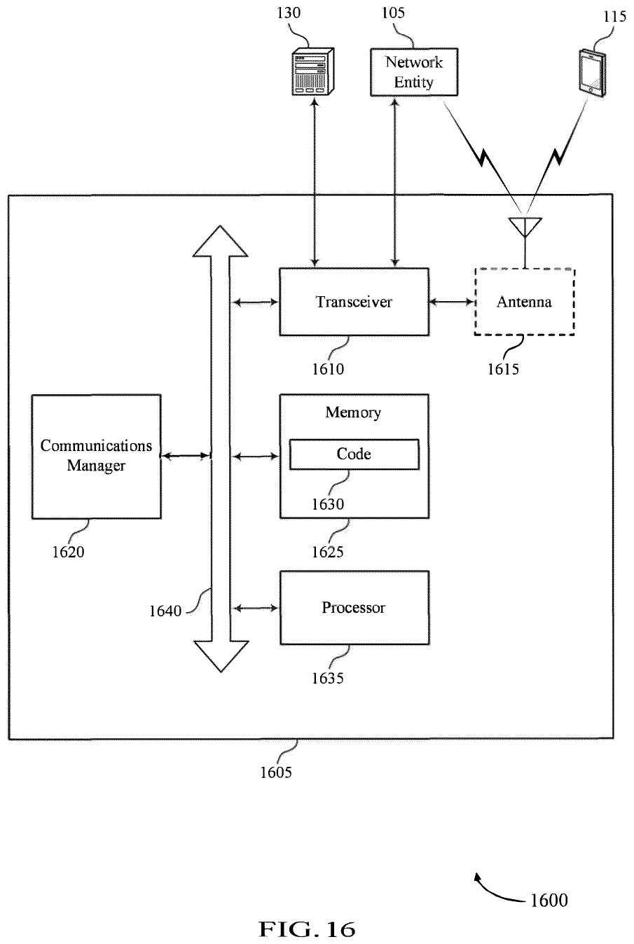

FIG. 16 shows a diagram of a system 1600 including a device 1605 that supports techniques for partial sidelink transmission using wideband operations in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting techniques for partial sidelink transmission using wideband operations). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity (e.g., the device 1605) in accordance with examples as disclosed herein. For example, the communications manager 1620 may be configured as or otherwise support a means for transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The communications manager 1620 may be configured as or otherwise support a means for transmitting a second control message that indicates, to the UE, one or more rules for identifying frequency resources of the set of multiple LBT sub-bands in which the partial sidelink messages are to be transmitted.

By including or configuring the communications manager 1620 in accordance with examples as described herein, the device 1605 may support techniques for improved communication reliability, more efficient utilization of communication resources, and improved coordination between devices.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of techniques for partial sidelink transmission using wideband operations as described herein, or the processor 1635 and the memory 1625 may be otherwise configured to perform or support such operations.

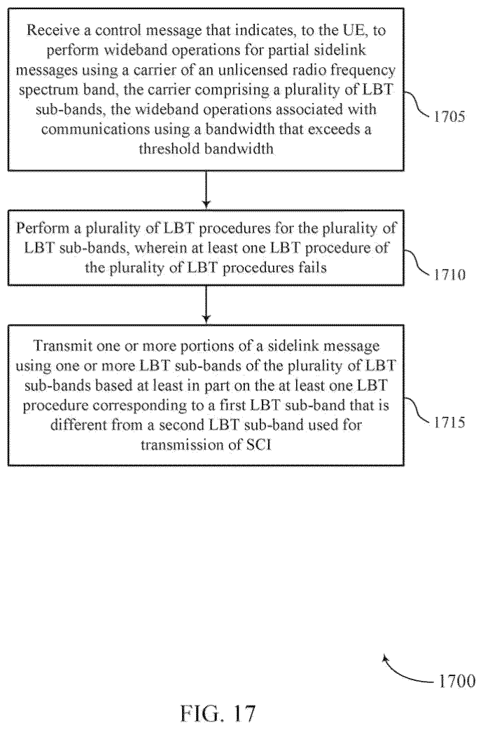

FIG. 17 shows a flowchart illustrating a method 1700 that supports techniques for partial sidelink transmission using wideband operations in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The operations of 1705 may be performed in accordance with examples as disclosed herein. In some examples, aspects of the operations of 1705 may be performed by a wideband operation component 1125 as described with reference to FIG. 11.

At 1710, the method may include performing a set of multiple LBT procedures for the set of multiple LBT sub-bands, where at least one LBT procedure of the set of multiple LBT procedures fails. The operations of 1710 may be performed in accordance with examples as disclosed herein. In some examples, aspects of the operations of 1710 may be performed by an LBT component 1130 as described with reference to FIG. 11.

At 1715, the method may include transmitting one or more portions of a sidelink message using one or more LBT sub-bands of the set of multiple LBT sub-bands based on the at least one LBT procedure corresponding to a first LBT sub-band that is different from a second LBT sub-band used for transmission of SCI. The operations of 1715 may be performed in accordance with examples as disclosed herein. In some examples, aspects of the operations of 1715 may be performed by a sidelink message component 1135 as described with reference to FIG. 11.

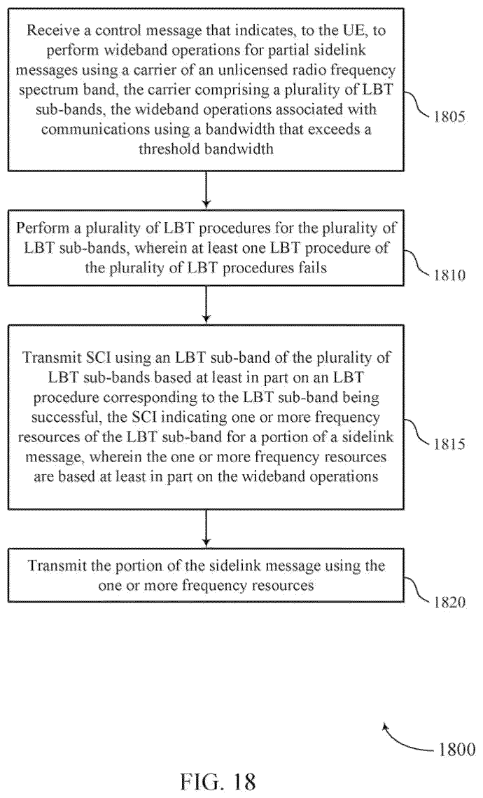

FIG. 18 shows a flowchart illustrating a method 1800 that supports techniques for partial sidelink transmission using wideband operations in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving a control message that indicates, to the UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The operations of 1805 may be performed in accordance with examples as disclosed herein. In some examples, aspects of the operations of 1805 may be performed by a wideband operation component 1125 as described with reference to FIG. 11.

At 1810, the method may include performing a set of multiple LBT procedures for the set of multiple LBT sub-bands, where at least one LBT procedure of the set of multiple LBT procedures fails. The operations of 1810 may be performed in accordance with examples as disclosed herein. In some examples, aspects of the operations of 1810 may be performed by an LBT component 1130 as described with reference to FIG. 11.

At 1815, the method may include transmitting SCI using an LBT sub-band of the set of multiple LBT sub-bands based on an LBT procedure corresponding to the LBT sub-band being successful, the SCI indicating one or more frequency resources of the LBT sub-band for a portion of a sidelink message, where the one or more frequency resources are based on the wideband operations. The operations of 1815 may be performed in accordance with examples as disclosed herein. In some examples, aspects of the operations of 1815 may be performed by an SCI component 1140 as described with reference to FIG. 11.

At 1820, the method may include transmitting the portion of the sidelink message using the one or more frequency resources. The operations of 1820 may be performed in accordance with examples as disclosed herein. In some examples, aspects of the operations of 1820 may be performed by a sidelink message component 1135 as described with reference to FIG. 11.

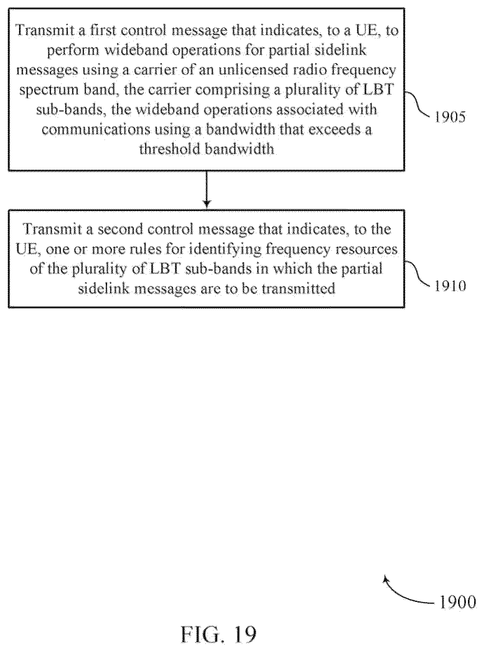

FIG. 19 shows a flowchart illustrating a method 1900 that supports techniques for partial sidelink transmission using wideband operations in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first control message that indicates, to a UE, to perform wideband operations for partial sidelink messages using a carrier of an unlicensed radio frequency spectrum band, the carrier including a set of multiple LBT sub-bands, the wideband operations associated with communications using a bandwidth that exceeds a threshold bandwidth. The operations of 1905 may be performed in accordance with examples as disclosed herein. In some examples, aspects of the operations of 1905 may be performed by a wideband operation indication component 1525 as described with reference to FIG. 15.

At 1910, the method may include transmitting a second control message that indicates, to the UE, one or more rules for identifying frequency resources of the set of multiple LBT sub-bands in which the partial sidelink messages are to be transmitted. The operations of 1910 may be performed in accordance with examples as disclosed herein. In some examples, aspects of the operations of 1910 may be performed by a rule indication component 1530 as described with reference to FIG. 15.

The following provides an overview of aspects of the present disclosure:

Aspect 1: A method for wireless communication at a UE, comprising: receiving a control message that indicates, to the UE, to perform wideband operations for partial sidelink messages using a carrier of an unlicensed radio frequency spectrum band, the carrier comprising a plurality of LBT sub-bands, the wideband operations associated with communications using a bandwidth that exceeds a threshold bandwidth; performing a plurality of LBT procedures for the plurality of LBT sub-bands, wherein at least one LBT procedure of the plurality of LBT procedures fails; and transmitting one or more portions of a sidelink message using one or more LBT sub-bands of the plurality of LBT sub-bands based at least in part on the at least one LBT procedure corresponding to a first LBT sub-band that is different from a second LBT sub-band used for transmission of SCI.

Aspect 2: The method of aspect 1, further comprising: performing a second plurality of LBT procedures for the plurality of LBT sub-bands, wherein an LBT procedure of the second plurality of LBT procedures fails; and refraining from transmitting a second sidelink message based at least in part on the LBT procedure corresponding to the second LBT sub-band used for transmission of the SCI.

Aspect 3: The method of any of aspects 1 through 2, further comprising: transmitting the SCI using a one or more sidelink control channel resources of the second LBT sub-band, wherein the SCI indicates or more respective sidelink shared channel resources of the one or more LBT sub-bands for the one or more portions of the sidelink message.

Aspect 4: The method of aspect 3, wherein the second LBT sub-band corresponds to a lowest set of frequencies of a plurality of sets of frequencies associated with the plurality of LBT sub-bands, and a sidelink control channel resource of the one or more sidelink control channel resources correspond to a lowest frequency of the second LBT sub-band.

Aspect 5: The method of any of aspects 1 through 4, wherein transmitting the one or more portions of the sidelink message comprises: transmitting respective portions of the sidelink message using respective LBT sub-bands of the one or more LBT sub-bands, wherein the respective LBT sub-bands correspond to successful LBT procedures.

Aspect 6: A method for wireless communication at a UE, comprising: receiving a control message that indicates, to the UE, to perform wideband operations for partial sidelink messages using a carrier of an unlicensed radio frequency spectrum band, the carrier comprising a plurality of LBT sub-bands, the wideband operations associated with communications using a bandwidth that exceeds a threshold bandwidth; performing a plurality of LBT procedures for the plurality of LBT sub-bands, wherein at least one LBT procedure of the plurality of LBT procedures fails; transmitting SCI using an LBT sub-band of the plurality of LBT sub-bands based at least in part on an LBT procedure corresponding to the LBT sub-band being successful, the SCI indicating one or more frequency resources of the LBT sub-band for a portion of a sidelink message, wherein the one or more frequency resources are based at least in part on the wideband operations; and transmitting the portion of the sidelink message using the one or more frequency resources.

Aspect 7: The method of aspect 6, further comprising: receiving a second control message that indicates, to the UE, one or more rules for indicating the one or more frequency resources of the LBT sub-band using the SCI, wherein the SCI is transmitted based at least in part on the second control message.

Aspect 8: The method of any of aspects 6 through 7, wherein transmitting the SCI comprises: transmitting a quantity of bits that indicates the one or more frequency resources, wherein the quantity of bits is based at least in part on the wideband operations and a frequency resource indicator value associated with the one or more frequency resources.

Aspect 9: The method of any of aspects 6 through 7, wherein transmitting the SCI comprises: transmitting a first SCI message comprising an indication of a quantity of contiguous frequency resources comprising the one or more frequency resources; and transmitting a second SCI message comprising an indication of a frequency location of a frequency resource of the quantity of contiguous frequency resources, wherein the frequency location is relative to a lowest frequency of a set of frequencies associated with the LBT sub-band.

Aspect 10: The method of aspect 9, wherein the frequency location of the frequency resource is indicated using one or more bits that correspond to an index associated with the frequency resource.

Aspect 11: The method of aspect 9, wherein the frequency location of the frequency resource is indicated using one or more bits that correspond to a status of the LBT procedure corresponding to the LBT sub-band.

Aspect 12: The method of any of aspects 6 through 7, wherein transmitting the SCI comprises: scrambling a portion of bits included in the SCI, wherein the one or more frequency resources are indicated based at least in part on the scrambled portion of bits.

Aspect 13: The method of aspect 12, wherein the scrambled portion of bits comprise CRC bits.

Aspect 14: The method of any of aspects 12 through 13, wherein the portion of bits are scrambled using an RNTI, and the one or more frequency resources are indicated based at least in part on the RNTI and an index associated with the LBT sub-band.

Aspect 15: The method of any of aspects 6 through 14, further comprising: transmitting second SCI using the LBT sub-band, the second SCI indicating that the portion of the sidelink message is to be transmitted using the wideband operations.

Aspect 16: A method for wireless communication at a network entity, comprising: transmitting a first control message that indicates, to a UE, to perform wideband operations for partial sidelink messages using a carrier of an unlicensed radio frequency spectrum band, the carrier comprising a plurality of LBT sub-bands, the wideband operations associated with communications using a bandwidth that exceeds a threshold bandwidth; and transmitting a second control message that indicates, to the UE, one or more rules for identifying frequency resources of the plurality of LBT sub-bands in which the partial sidelink messages are to be transmitted.

Aspect 17: The method of aspect 16, wherein transmitting the second control message comprises: transmitting an indication of a rule of the one or more rules that indicates, to the UE, to identify the frequency resources using a quantity of bits transmitted using SCI, wherein the quantity of bits is based at least in part on the wideband operations and a frequency resource indicator value associated with the frequency resources.

Aspect 18: The method of any of aspects 16 through 17, wherein transmitting the second control message comprises: transmitting an indication of a rule of the one or more rules that indicates, to the UE, to identify the frequency resources using a first SCI message that comprises an indication of a quantity of contiguous frequency resources comprising the frequency resources and a second SCI message comprising an indication of a frequency location of a frequency resource of the quantity of contiguous frequency resources, wherein the frequency location is relative to a lowest frequency of a set of frequencies associated with an LBT sub-band of the plurality of LBT sub-bands.

Aspect 19: The method of aspect 18, wherein the rule further indicates that the frequency location of the frequency resource is to be identified using one or more bits that correspond to an index associated with the frequency resource.

Aspect 20: The method of aspect 18, wherein the rule further indicates that the frequency location of the frequency resource is identified using one or more bits that correspond to a status of an LBT procedure corresponding to the LBT sub-band.

Aspect 21: The method of any of aspects 16 through 17, wherein transmitting the second control message comprises: transmitting an indication of a rule of the one or more rules that indicates, to the UE, to identify the frequency resources using a portion of bits that are scrambled and included in a SCI message.

Aspect 22: The method of aspect 21, wherein the rule further indicates that the portion of bits comprise CRC bits.

Aspect 23: The method of any of aspects 21 through 22, wherein the rule further indicates that the portion of bits are to be scrambled using an RNTI, and the frequency resources are to be indicated based at least in part on the RNTI and an index associated with a respective LBT sub-band of the plurality of LBT sub-bands.

Aspect 24: An apparatus for wireless communication at a UE, comprising a processor; memory coupled with the processor; and instructions stored in the memory and executable by the processor to cause the apparatus to perform a method of any of aspects 1 through 5.

Aspect 25: An apparatus for wireless communication at a UE, comprising at least one means for performing a method of any of aspects 1 through 5.

Aspect 26: A non-transitory computer-readable medium storing code for wireless communication at a UE, the code comprising instructions executable by a processor to perform a method of any of aspects 1 through 5.

Aspect 27: An apparatus for wireless communication at a UE, comprising a processor; memory coupled with the processor; and instructions stored in the memory and executable by the processor to cause the apparatus to perform a method of any of aspects 6 through 15.

Aspect 28: An apparatus for wireless communication at a UE, comprising at least one means for performing a method of any of aspects 6 through 15.

Aspect 29: A non-transitory computer-readable medium storing code for wireless communication at a UE, the code comprising instructions executable by a processor to perform a method of any of aspects 6 through 15.

Aspect 30: An apparatus for wireless communication at a network entity, comprising a processor; memory coupled with the processor; and instructions stored in the memory and executable by the processor to cause the apparatus to perform a method of any of aspects 16 through 23.

Aspect 31: An apparatus for wireless communication at a network entity, comprising at least one means for performing a method of any of aspects 16 through 23.

Aspect 32: A non-transitory computer-readable medium storing code for wireless communication at a network entity, the code comprising instructions executable by a processor to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive a control message that indicates, to the UE, to perform wideband operations for partial sidelink messages using a carrier of an unlicensed radio frequency spectrum band, the carrier comprising a plurality of listen-before-talk (LBT) sub-bands, the wideband operations associated with communications using a bandwidth that exceeds a threshold bandwidth;
perform a plurality of LBT procedures for the plurality of LBT sub-bands, wherein at least one LBT procedure of the plurality of LBT procedures fails; and
transmit one or more portions of a sidelink message using one or more LBT sub-bands of the plurality of LBT sub-bands based at least in part on the at least one LBT procedure corresponding to a first LBT sub-band that is different from a second LBT sub-band used for transmission of sidelink control information.

2. The apparatus of claim 1, wherein the instructions are further executable by the processor to cause the apparatus to:
perform a second plurality of LBT procedures for the plurality of LBT sub-bands, wherein an LBT procedure of the second plurality of LBT procedures fails; and
refrain from transmitting a second sidelink message based at least in part on the LBT procedure corresponding to the second LBT sub-band used for transmission of the sidelink control information.

3. The apparatus of claim 1, wherein the instructions are further executable by the processor to cause the apparatus to:
transmit the sidelink control information using a one or more sidelink control channel resources of the second LBT sub-band, wherein the sidelink control information indicates or more respective sidelink shared channel resources of the one or more LBT sub-bands for the one or more portions of the sidelink message.

4. The apparatus of claim 3, wherein:
the second LBT sub-band corresponds to a lowest set of frequencies of a plurality of sets of frequencies associated with the plurality of LBT sub-bands, and
a sidelink control channel resource of the one or more sidelink control channel resources correspond to a lowest frequency of the second LBT sub-band.

5. The apparatus of claim 1, wherein the instructions to transmit the one or more portions of the sidelink message are executable by the processor to cause the apparatus to:
transmit respective portions of the sidelink message using respective LBT sub-bands of the one or more LBT sub-bands, wherein the respective LBT sub-bands correspond to successful LBT procedures.

6. An apparatus for wireless communication at a user equipment (UE), comprising:
a processor;
memory coupled with the processor; and
instructions stored in the memory and executable by the processor to cause the apparatus to:
receive a control message that indicates, to the UE, to perform wideband operations for partial sidelink messages using a carrier of an unlicensed radio frequency spectrum band, the carrier comprising a plurality of listen-before-talk (LBT) sub-bands, the wideband operations associated with communications using a bandwidth that exceeds a threshold bandwidth;
perform a plurality of LBT procedures for the plurality of LBT sub-bands, wherein at least one LBT procedure of the plurality of LBT procedures fails;
transmit sidelink control information using an LBT sub-band of the plurality of LBT sub-bands based at least in part on an LBT procedure corresponding to the LBT sub-band being successful, the sidelink control information indicating one or more frequency resources of the LBT sub-band for a portion of a sidelink message, wherein the one or more frequency resources are based at least in part on the wideband operations; and
transmit the portion of the sidelink message using the one or more frequency resources.

7. The apparatus of claim 6, wherein the instructions are further executable by the processor to cause the apparatus to:
receive a second control message that indicates, to the UE, one or more rules for indicating the one or more frequency resources of the LBT sub-band using the sidelink control information, wherein the sidelink control information is transmitted based at least in part on the second control message.

8. The apparatus of claim 6, wherein the instructions to transmit the sidelink control information are executable by the processor to cause the apparatus to:
transmit a quantity of bits that indicates the one or more frequency resources, wherein the quantity of bits is based at least in part on the wideband operations and a frequency resource indicator value associated with the one or more frequency resources.

9. The apparatus of claim 6, wherein the instructions to transmit the sidelink control information are executable by the processor to cause the apparatus to:
transmit a first sidelink control information message comprising an indication of a quantity of contiguous frequency resources comprising the one or more frequency resources; and
transmit a second sidelink control information message comprising an indication of a frequency location of a frequency resource of the quantity of contiguous frequency resources, wherein the frequency location is relative to a lowest frequency of a set of frequencies associated with the LBT sub-band.

10. The apparatus of claim 9, wherein the frequency location of the frequency resource is indicated using one or more bits that correspond to an index associated with the frequency resource.

11. The apparatus of claim 9, wherein the frequency location of the frequency resource is indicated using one or more bits that correspond to a status of the LBT procedure corresponding to the LBT sub-band.

12. The apparatus of claim 6, wherein the instructions to transmit the sidelink control information are executable by the processor to cause the apparatus to:
scramble a portion of bits included in the sidelink control information, wherein the one or more frequency resources are indicated based at least in part on the scrambled portion of bits.

13. The apparatus of claim 12, wherein:
the scrambled portion of bits comprise cyclic redundancy check bits.

14. The apparatus of claim 12, wherein:
the portion of bits are scrambled using a radio network temporary identifier, and
the one or more frequency resources are indicated based at least in part on the radio network temporary identifier and an index associated with the LBT sub-band.

15. The apparatus of claim 6, wherein the instructions are further executable by the processor to cause the apparatus to:
transmit second sidelink control information using the LBT sub-band, the second sidelink control information indicating that the portion of the sidelink message is to be transmitted using the wideband operations.

16. An apparatus for wireless communication at a network entity, comprising:
a processor;
memory coupled with the processor; and
instructions stored in the memory and executable by the processor to cause the apparatus to:
transmit a first control message that indicates, to a user equipment (UE), to perform wideband operations for partial sidelink messages using a carrier of an unlicensed radio frequency spectrum band, the carrier comprising a plurality of listen-before-talk (LBT) sub-bands, the wideband operations associated with communications using a bandwidth that exceeds a threshold bandwidth; and
transmit a second control message that indicates, to the UE, one or more rules for identifying frequency resources of the plurality of LBT sub-bands in which the partial sidelink messages are to be transmitted.

17. The apparatus of claim 16, wherein the instructions to transmit the second control message are executable by the processor to cause the apparatus to:
transmit an indication of a rule of the one or more rules that indicates, to the UE, to identify the frequency resources using a quantity of bits transmitted using sidelink control information, wherein the quantity of bits is based at least in part on the wideband operations and a frequency resource indicator value associated with the frequency resources.

18. The apparatus of claim 16, wherein the instructions to transmit the second control message are executable by the processor to cause the apparatus to:
transmit an indication of a rule of the one or more rules that indicates, to the UE, to identify the frequency resources using a first sidelink control information message that comprises an indication of a quantity of contiguous frequency resources comprising the frequency resources and a second sidelink control information message comprising an indication of a frequency location of a frequency resource of the quantity of contiguous frequency resources, wherein the frequency location is relative to a lowest frequency of a set of frequencies associated with an LBT sub-band of the plurality of LBT sub-bands.

19. The apparatus of claim 18, wherein the rule further indicates that the frequency location of the frequency resource is to be identified using one or more bits that correspond to an index associated with the frequency resource.

20. The apparatus of claim 18, wherein the rule further indicates that the frequency location of the frequency resource is identified using one or more bits that correspond to a status of an LBT procedure corresponding to the LBT sub-band.

21. The apparatus of claim 16, wherein the instructions to transmit the second control message are executable by the processor to cause the apparatus to:
transmit an indication of a rule of the one or more rules that indicates, to the UE, to identify the frequency resources using a portion of bits that are scrambled and included in a sidelink control information message.

22. The apparatus of claim 21, wherein the rule further indicates that the portion of bits comprise cyclic redundancy check bits.

23. The apparatus of claim 21, wherein:
the rule further indicates that the portion of bits are to be scrambled using a radio network temporary identifier, and
the frequency resources are to be indicated based at least in part on the radio network temporary identifier and an index associated with a respective LBT sub-band of the plurality of LBT sub-bands.

24. A method for wireless communication at a user equipment (UE), comprising:
receiving a control message that indicates, to the UE, to perform wideband operations for partial sidelink messages using a carrier of an unlicensed radio frequency spectrum band, the carrier comprising a plurality of listen-before-talk (LBT) sub-bands, the wideband operations associated with communications using a bandwidth that exceeds a threshold bandwidth;
performing a plurality of LBT procedures for the plurality of LBT sub-bands, wherein at least one LBT procedure of the plurality of LBT procedures fails; and
transmitting one or more portions of a sidelink message using one or more LBT sub-bands of the plurality of LBT sub-bands based at least in part on the at least one LBT procedure corresponding to a first LBT sub-band that is different from a second LBT sub-band used for transmission of sidelink control information.

25. The method of claim 24, further comprising:
performing a second plurality of LBT procedures for the plurality of LBT sub-bands, wherein an LBT procedure of the second plurality of LBT procedures fails; and
refraining from transmitting a second sidelink message based at least in part on the LBT procedure corresponding to the second LBT sub-band used for transmission of the sidelink control information.

26. The method of claim 24, further comprising:
transmitting the sidelink control information using a one or more sidelink control channel resources of the second LBT sub-band, wherein the sidelink control information indicates or more respective sidelink shared channel resources of the one or more LBT sub-bands for the one or more portions of the sidelink message.

27. The method of claim 26, wherein:
the second LBT sub-band corresponds to a lowest set of frequencies of a plurality of sets of frequencies associated with the plurality of LBT sub-bands, and
a sidelink control channel resource of the one or more sidelink control channel resources correspond to a lowest frequency of the second LBT sub-band.

28. The method of claim 24, wherein transmitting the one or more portions of the sidelink message comprises:
transmitting respective portions of the sidelink message using respective LBT sub-bands of the one or more LBT sub-bands, wherein the respective LBT sub-bands correspond to successful LBT procedures.
